(19) United States
(12) Patent Application Publication
(10) Pub. No.: US 2004/0260697 A1
(43) Pub. Date: Dec. 23, 2004

(54) Apparatus for and method of evaluating named entities

(75) Inventors: Hiroyuki Ohnuma, Tokyo (JP); Yoshitaka Hamaguchi, Tokyo (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/766,489

(22) Filed: Jan. 29, 2004

(30) Foreign Application Priority Data
Jun. 23, 2003 (JP) 2003-178336

(51) Int. Cl. G06F 7/00

(52) U.S. Cl. 707/5

(57) ABSTRACT

An evaluation apparatus and method capable of accurately evaluating the significance of named entities mentioned in a set of documents.

A word significance decision section 160 decides the significance of each personal name acquired by a word acquisition section 140. A locational relation calculation section 162 calculates the locational relation between respective documents mentioning each personal name with reference to the URL of each document stored in a location information storage section 150 and further calculates the weight of each document. A significance calculation section 166 decides the significance of each personal name based on the weight of each document which is calculated by the locational relation calculation section 162. The high significance is given to a personal name mentioned in a lot of documents which are mutually less relevant to one another.

### BACKGROUND OF THE INVENTION

1. Field of the Invention

The present invention relates to apparatus for and method of evaluating named entities.

2. Description of the Related Art

Up to the present, in order to efficiently and accurately retrieve a specified information from among a large quantity of documents as publicly disclosed on a network, for example, an internet and so on, there has been widely used a technique of combining a retrieval keyword inputted to a retrieval system by a user with a keyword relevant to this retrieval keyword (a relevant keyword). This technique is constructed from a view point “It might be not always possible for the user to precisely recollect an appropriate retrieval keyword.”

The Japanese Patent Laid-Open Publication No. 11-25108 (referred as “Patent Document 1” hereinafter) discloses an apparatus extracting relevant keywords based on the statistical information with respect to words appearing in a plurality of documents. In this relevant keyword extraction processing, there are used various parameters, for example, a document weight, an appearance location, a word length, a word assortment, a coincidence status of character strings, TF (Term Frequency)/IDF (Inverse Document Frequency) and so forth. According to the apparatus as disclosed by the Patent Document 1, if a certain personal name frequently appears in a document assembly made up of a plurality of documents, the apparatus comes to judge that a person specified by such name is an important person.

However, if the significance of a character string (words) indicative of a personal name described in the document assembly, in other words, the significance of that person is evaluated depending only on the number of appearing times of that character string, there happens a case where such evaluation per se is lacking in accuracy. For example, in the home page of a certain research institute disclosed on the internet, it is natural that the name of a certain person belonging to that research institute frequently appears on the home page of the institute. Accordingly, even if the same personal name repetitively appears in the document assembly constituting the home page of the specific research institute, it is not always possible to say that the significance of the person having such name is high.

The present invention has been made in view of problems as described above, and an object of it is to provide novel and improved evaluation apparatus and evaluation method capable of accurately evaluating the significance of an inherent expression character string, we call it “named entity”, and so forth as described in the document assembly.

In the invention, a wording “named entity” includes organization name (company name, association name, etc.), personal name, proper noun such as place name, product name, common noun such as service name, combination of these nouns and adjectives, and newly coined word of which the assortment is difficult.

### SUMMARY OF THE INVENTION

In order to solve problems as described above and to achieve the object, according to the first aspect of the invention, there is provided an evaluation apparatus of named entities, which gives an evaluation value to the named entities included in a document. This apparatus includes a document weight calculation section which defines a mutual relevance among a plurality of documents including the named entities as an object to be given the evaluation value, and calculating the weight value of each document based on the relevance concerned; and an evaluation value calculation section calculating the evaluation value of the named entities by carrying out the calculation processing using the weight value of each document.

According to the apparatus like this, for example, it becomes possible to set a document less relevant to the other document at a large weight value and to give a high evaluation value to named entities mentioned in the document of the large weight value. Accordingly, even if a certain named entity is mentioned in a lot of document, it does not naturally occur that such named entity is given a high evaluation value. Rather, a high evaluation value comes to be given to a named entity mentioned in an independent document less relevant to the other documents is given.

It is preferable that a plurality of documents is managed under a tree structure, and the document weight calculation section defines the relevance between respective documents corresponding to the existing location of each document in said tree structure. With this, the relevance between respective documents is qualitatively defined. As the result of this, the evaluation value given to the named entities is improved in its accuracy.

It is preferable that the document weight calculation section increases or decreases the weight value of one document and the other one document corresponding to the number of nodes of the tree structure common to the one document concerned and the other one document concerned and/or corresponding to the number of branches of the tree structure existing between the one document concerned and the other one document concerned. Besides, if one document and the other one document are managed under the different trees, the document weight calculation section maximizes or minimizes the weight value of the one document concerned and the other one document concerned.

The document weight calculation section may define the relevance between respective documents by using reference relation between respective documents. In this case, it is preferable that the document weight calculation section increases or decreases the weight value of one document and the other one document corresponding to whether or not there exists the third document which directly or indirectly refers to both of the one document concerned and the other one document concerned and/or corresponding to whether or not the one document concerned directly or indirectly refers to the other one document concerned. Furthermore, it is preferable that if there is no other one document referring to one document, the document weight calculation section maximizes (minimizes according to circumstances) the weight value of the one document concerned.

Furthermore, an evaluation apparatus of named entities according to the invention is provided with a document collection section collecting said plurality of document and a document relevance storage section storing the mutual relevance of the documents collected by said document collection section. According to this constitution, the evaluation value of the named entities can be efficiently calculated within a short period of time.

In order to solve problems as described above and to achieve the object, according to the second aspect of the invention, there is provided an evaluation method of named entities. This evaluation method includes a document weight calculation process defining a mutual relevance among a plurality of documents including the named entities as an object to be given the evaluation value and calculating the weight value of said each document based on the relevance concerned, and an evaluation value calculation process calculating the evaluation value of said named entities by carrying out the calculation processing using the weight value of said each document.

According to this method, it becomes possible that a high evaluation value is given to the named entities mentioned in an independent document less relevant to the other document.

Furthermore, an evaluation method of named entities includes a document collection process collecting said plurality of document and a document relevance storage process storing the mutual relevance of the documents collected by said document collection process, wherein said document collection process and said document relevance storage process are carried out at least before said document weight calculation process. According to this method, the evaluation value of the named entities can be efficiently calculated within a short period of time.

### BRIEF DESCRIPTION OF THE DRAWINGS

FIG. 1 is a block diagram showing the constitution of a word significance judgment device of the first embodiment according to the invention.

FIG. 2 is a diagram for explaining a table stored in a word information storage section belonging to the word significance judgment device as shown in FIG. 1.

FIG. 3 is a table showing URL's of documents applied to the embodiment according to the invention is applied.

FIG. 4 is a flowchart showing a total processing operation of the word significance judgment device as shown in FIG. 1.

FIG. 5 is a flowchart (part 1) showing the processing operation of a locational relation calculation section belonging to the word significance judgment device as shown in FIG. 1.

FIG. 6 is a flowchart (part 2) showing the processing operation of a locational relation calculation section belonging to the word significance judgment device as shown in FIG. 1.

FIG. 7 is a flowchart showing the processing operation of a significance calculation section belonging to the word significance judgment device as shown in FIG. 1.

FIG. 8 is a block diagram showing the movement process from the storage location of the document with identifier doc1 to the storage location of the document with identifier doc6.

FIG. 9 is a block diagram showing the constitution of a word significance judgment device of the second embodiment according to the invention.

FIG. 10 is a diagram showing a reference relation applied to the embodiment according to the invention.

FIG. 11 is a diagram for explaining a table stored in a link information storage section belonging to the word significance judgment device as shown in FIG. 9.

FIG. 12 is a flowchart showing a total processing operation of the word significance judgment device as shown in FIG. 9.

FIG. 13 is a table showing the operation result of the link relation search section belonging to the word significance judgment device as shown in FIG. 9.

FIG. 14 is a flowchart showing the processing operation of an inter-document relation decision section belonging to the word significance judgment device as shown in FIG. 9.

FIG. 15 is a flowchart showing the processing operation of a significance calculation section belonging to the word significance judgment device as shown in FIG. 9.

FIG. 16 is a block diagram showing the constitution of a word significance judgment device of the third embodiment according to the invention.

FIG. 17 is a table showing the processing result of the locational relation registration section belonging to the word significance judgment device as shown in FIG. 16.

FIG. 18 is a flowchart showing the document collecting operation of the word significance judgment device as shown in FIG. 16.

FIG. 19 is a flowchart showing the processing operation of a locational relation registration section belonging to the word significance judgment device as shown in FIG. 16.

### DETAILED DESCRIPTION OF THE PREFERRED EMBODIMENTS

Several preferred embodiments of an evaluation apparatus and an evaluation method of named entities according to the invention will now be described in detail with reference to the accompanying drawings. In the following description as well as in the accompanying drawings, constituents of the invention having approximately same function and constitution are denoted with the same reference numerals and symbols, thereby omitting repetitive description thereabout.

### First Embodiment

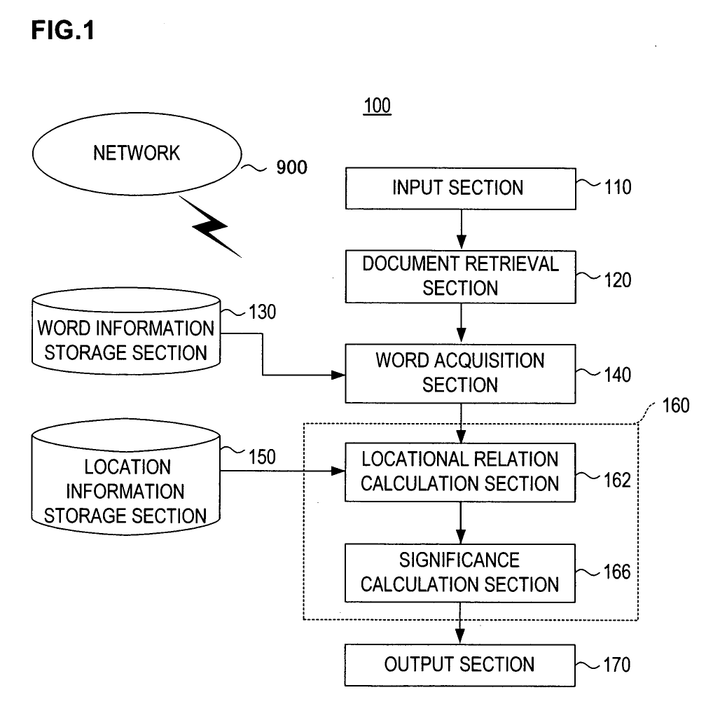

A word significance judgment device 100 as an evaluation apparatus of the named entities according to the first embodiment of the invention receives a retrieval keyword from a user and extracts one or two or more named entities (here, “a personal name”) related to this retrieval keyword. This word significance judgment device 100 has the function of judging the significance (evaluation value) of the extracted named entities as well as the function of returning it to the user, and as shown in FIG. 1, the word significance judgment device 100 is made up of an input section 110, a document retrieval section 120, a word information storage section 130, a word acquisition section 140, a location information storage section 150, a word significance decision section 160, and an output section 170. Besides, the word significance decision section 160 is made up of a locational relation calculation section (document weight calculation section) 162 and a significance calculation section (evaluation value calculation section) 166.

The input section 110 receives a retrieval keyword as a retrieval request from the user. In the following, the explanation will be made referring to a case where a retrieval keyword is “a fuel cell.” Besides, the input section 110 can receive not only words but also idiomatic phrases, ordinary sentences as the retrieval keyword.

The document retrieval section 120 retrieves one or two or more documents conforming to the retrieval keyword (or mentioning the retrieval keyword) from all the documents publicly disclosed on the network 900 or form the documents belonging to a predetermined category and outputs an identifier for each document. In this case, the network 900 may be a public network such as the internet or a local network such as an intranet.

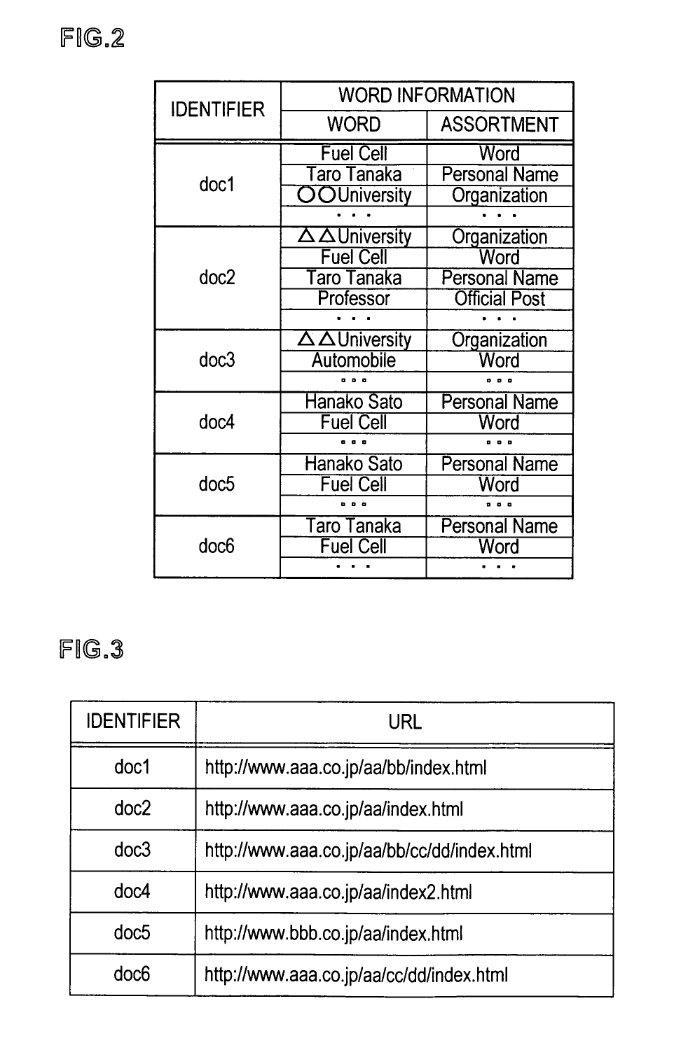

The word information storage section 130 already stores the information (word name, word assortment, etc.) with regard to the word (or character string) appearing in all the documents publicly disclosed in the network 900 or in the documents belonging to a predetermined category at the time when the user inputs a retrieval keyword to the input section 110. For example, the word information storage section 130 holds the document identifier and the word information in the form of a table as shown in FIG. 2. The word information is constituted with the word and the word assortment. Personal name, organization name, official post name, place name and so forth are used for word assortment.

The word acquisition section 140 receives a list of the identifier of the document as retrieved by the document retrieval section 120 from this document retrieval section 120. Then, the word acquisition section 140 refers to the word information storage 130 by using the identifier list and acquires the word (here, the personal name of a predetermined assortment included in each document identified by each identifier.

Location information storage section 150 already stores the location information with regard to all the documents publicly disclosed in the network 900 or in the documents belonging to a predetermined category, at the time when the user inputs a retrieval keyword to the input section 110. For example, if the network 900 is the internet, it is preferable to use the URL (Uniform Resource Locater) as shown in FIG. 3 of each document as the location information of each document as stored in the location information storage section 150.

Besides, the information with respect to the word stored in the word information storage section 130 and the location information of each document stored in the location information storage section 150 can be acquired, for example, by means of a robot (not shown) collecting the document from the WWW (World Wide Web) and named entities extraction device (not shown) extracting the named entities (e.g., proper nouns) such as the personal name, the organization name and so forth from the collected document. For example, the device as described in the following document can be used for extracting the named entities of the proper noun and others among from character strings mentioned in the document.

J. Fukumoto, M. Shimohata, F. Masui “Comparison of Language in Japanese and English in Extraction of Proper Noun”, “TECHNICAL REPORT OF IEICE”, NLC 98-21 (1998-07).

The word significance decision section 160 decides the significance with regard to each personal name acquired by the word acquisition section 140.

In order to decide the significance of each personal name, the locational relation calculation section 162 belonging to the word significance decision section 160 refers to the URL of each document stored in the location information storage section 150 and calculates the locational relation (relational degree) between documents describing each personal name, and further calculates the weight of each document. The operation of this locational relation calculation section 162 will be described in detail later.

The significance calculation section 166 belonging to the word significance decision section 160 decides the significance of each personal name based on the weight of each document calculated by the locational relation calculation section 162. The operation of the significance calculation section 166 will be described in detail later.

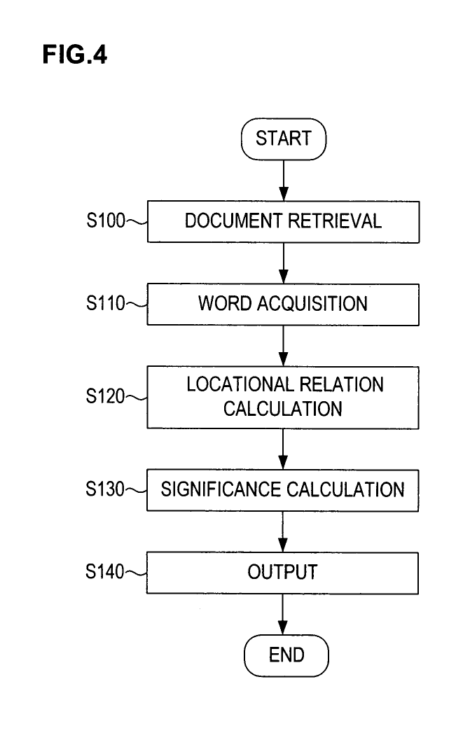

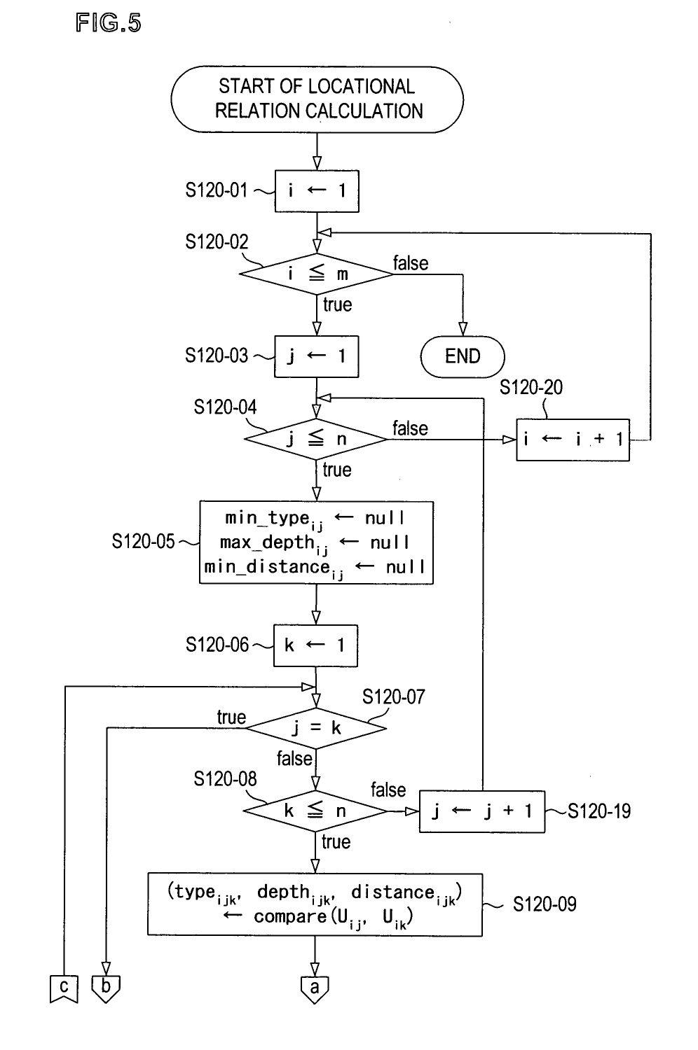

The operation of the word significance judgment device 100 as constituted as described above according to this embodiment will now be described referring to FIGS. 4 to FIG. 8.

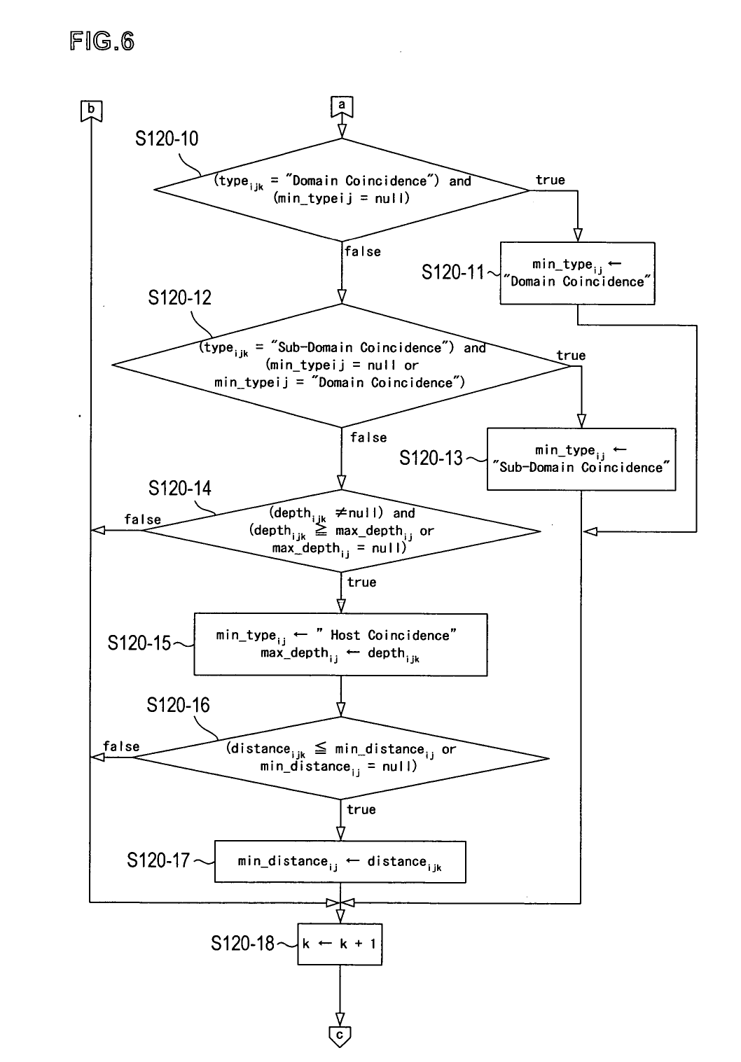

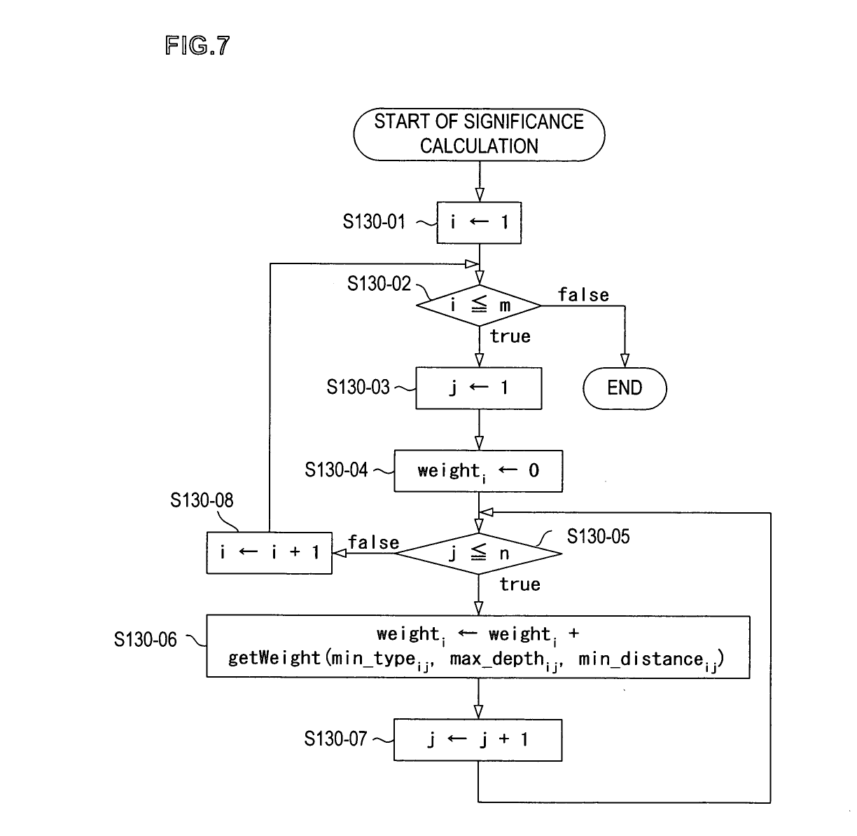

FIG. 4 is a flowchart showing a total processing operation of the word significance judgment device 100 of this embodiment. FIGS. 5 and 6 are detailed flowcharts showing the operation of the locational relation calculation section 162 (step S 120) while FIG. 7 is a detailed flowchart showing the operation of the significance calculation section 166 (step S130).

In the following, the operation of the word significance judgment device 100 according to this embodiment will be described referring to a case where the most important person relevant to a retrieval keyword “fuel cell” is extracted from a plurality of documents publicly disclosed on a network 900.

(Step S100)

First of all, when the retrieval keyword “fuel cell” is inputted to the input section 110, the document retrieval section 120 retrieves a document or documents in which the retrieval keyword “fuel cell” is described, from among a plurality of documents publicly disclosed on the network 900. For example, if documents (document assembly) publicly disclosed on the network 900 are six documents (identifiers doc1 to doc6) as shown in FIG. 2, five documents (identifiers doc1, doc2, doc4, doc5 and doc6) except the document (identifier doc3) are conformable to the retrieval keyword “fuel cell.” Then, the document retrieval section 120 gives the identifiers doc1, doc2, doc4, doc5 and doc6 of retrieved conformable documents to the word acquisition section 140, in the form of a list.

(Step S110)

In the next, the word acquisition 140 refers to the word information (FIG. 2) stored in the word information section 130. Then, the word acquisition section 140 selects the documents with identifiers doc1, doc2, doc4, doc5, and doc6 constituting the list as given from the document retrieval section 120, and acquires words of which the assortment is “personal name” from among the words described in these documents.

For example, if the word information section 130 stores the word information as shown FIG. 2, the word acquisition section 140 acquires “Taro Tanaka” respectively from the documents with identifiers doc1, doc2, and doc6 as well as “Hanako Sato” respectively from the documents with identifiers doc4 and doc5.

After acquiring personal names from each document, the word acquisition section 140 collects character strings corresponding to the identical personal names by means of the pattern matching method and outputs the collection result as a list in the form of “Personal name—Identifiers of the document including the said personal name.” Output examples are as follows.

“Taro Tanaka”—doc1, doc2, doc6

“Hanako Sato”—doc4, doc5.

(Step S120)

In the next, the locational relation calculation section 162 belonging to the word significance decision section 160 calculates the locational relation among a plurality of documents describing the said personal name with regard to each personal name, based on the list outputted from the word acquisition section 140.

With regard to the personal name “Taro Tanaka,” as there are documents of three identifiers of doc1, doc2 and doc6 as described above, the locational relation is calculated with respect to the following three kinds of document combination.

(1) The document with identifier doc1 and the document with identifier doc2.

(2) The document with identifier doc2 and the document with identifier doc6.

(3) The document with identifier doc6 and the document with identifier doc1.

Regarding the personal name “Hanako Sato,” as there are two documents with identifiers of doc4 and doc5 as described above, the locational relation is calculated with respect to the following one kind of document combination.

(1) The document with identifier doc4 and the document with identifier doc5.

The locational relation calculation section 162 decides a document standing at the nearest distance (referred to as “proximity document” hereinafter) from each of the documents, based on the locational relation of each document combination.

In this embodiment, each document is managed under the directory structure (i.e. tree structure), and a term “distance” between two documents means an interval which is defined based on the directory, for the purpose of data management of both documents. According to this embodiment, “Locational relation” between two documents has the following three attributes, one being “Relation type of both documents” (referred to as “Relation type” hereafter), the second being “Directory depth common to both document” (referred to as “Common directory depth” hereinafter), and the third being “Number of directories passed through when moving from the storage location of one document to the storage location of the other document” (referred to as “Transit directory number” thereinafter).

In the next, the locational relation of each document will be explained in view of the data management by means of the tree structure. Two documents are located at two “leaves,” respectively, while “Common directory depth” corresponds to the number of “nodes” common to two leaves. “Transit directory number” corresponds to the number of “branches” existing between two leaves.

Next, there will be explained each of attributes which are “Relation type”, “Common directory depth,” and “Transit directory number.”

When deciding the attribute “Relation type,” the URL of both documents is used. The value that the attribute “Relation type” can take is either one of “Irrelevance,” “Domain coincidence,” “Sub-domain coincidence,” or “Host coincidence.” If the value is “Irrelevance”, the attribute “Relation type” is set at a value of “null” (empty).

Setting of attribute “Relation type” will now be described by way of a concrete example. Now, let us consider a certain document (called “document A” temporarily), of which the URL is: “http://www. sub1.aa.cojp/bb/cc/doc_A.htm1.” In this URL, “www” indicates the name of a machine, “sub1” the name of a sub-domain, “aa.ccjp” the name of a domain, “bb/cc/” the name of a directory, and “doc_A.htm1” a file name (the name of a document). The relation type of the document A and an objective document (called “document B” temporarily) to be compared is decided in correspondence with the URL of the document B as described below.

(Case 1)

If the domain to which the document B belongs is different from the domain to which the document A belongs, it is judged that the document B exists at a distance from the document A exceeding a standard distance and the attribute “Relation type” is set at a value of null. For example, if the URL of the document B is “http://www. sub1.dd.co.jp/bb/cc/doc_B.htm1,” this corresponds to [Relation type=null]. In this embodiment, if the domain to which the document B belongs, is different from the domain to which the document A belongs, it is determined that these documents are managed under different tree structures, respectively.

(Case 2)

If documents A and B belong to the same domain but belong to different sub-domains, respectively, the attribute “Relation type” is set at a value of “Domain coincidence.” For example, if the URL of the document B is:

“http://www.sub2.aa.co.jp/bb/cc/doc_B.htm1,” or

“http://www.aa.co.jp/bb/cc/doc_B.htm1,” (no sub-main),

this corresponds to [Relation type=“domain coincidence”].

(Case 3)

If documents A and B belong to the same domain as well as the same sub-domain but belong to different servers (machines), respectively, “Sub-domain coincidence” is ser to the attribute “Relation type” For example, if the URL of the document B is “http://www2.sub1.aa.co.jp/bb/cc/doc_B.htm1,” this corresponds to [Relation type=“domain coincidence”]. Besides, if no domain name is included in each URL of documents to be compared, it is regarded that both documents belong to the same domain. For example, if the URL of the document A is:

“http://www.aa.co.jp/bb/cc/doc_A.htm1,”

and the URL of the document B is:

“http://www2.aa.co.jp/bb/cc/doc_B.htm1,”

both URL's coincides with each other at the point that they have no sub-domain, thus the relation type of documents A and B corresponding to “Sub-domain coincidence.”

(Case 4)

If the document B belongs to the same domain, and the same sub-domain and further the same server (machine) as the document A, the attribute “Relation type” is set at a value of “Host coincidence.” For example, if the URL of the document B is:

“http://www.sub1.aa.co.jp/bb/cc/doc_B.htm1,” or

“http://www.sub1.aa.co.jp/ee/doc_B.htm1,” (directory difference), this relation type corresponds to [Relation type=“Host coincidence”].

In the way as described above, there is determined the value of “Relation type” among three attributes of the locational relation between two documents. The distance between two documents becomes closer in the order of (Case 1) to (Case 4). In Case 4 where two documents most closely approach to each other, in other words, if the attribute “Relation type” is set at “Host coincidence,” remaining two attributes “Common directory depth” and “Transit directory number” are set at a value corresponding to the location of two documents to be compared. Besides, in (Case 1) to (Case 3), that is, if the attribute “Relation type” is set at either one of “null,” “Domain coincidence” or “Sub-domain coincidence,” the attribute “Common directory depth” and the attribute “Transit directory number” are set at a value of “null”

If the attribute “Relation type” is set at “Host coincidence,” the attribute “Common directory depth” is at the directory depth common to two documents as comparison objects. For example, when comparing the document of the identifier doc1 with the document of the identifier doc6, as the common directory is “aa/,” the attribute “Common directory depth” of “Locational relation” between these two documents is set at a value “1.”

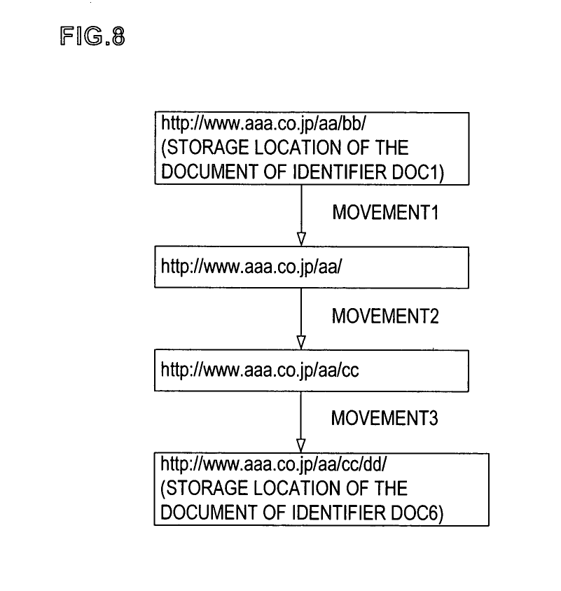

Besides, if the attribute “Relation type” is set at “Host coincidence,” the attribute “Transit directory number” is set at the number of the directories, which one of two documents to be compared has to pass through when it moves from one document storage location to the other. For example, when comparing the document of the identifier doc1 with the document of the identifier doc6 as shown in FIG. 2, in order to move from the storage location of the document of the identifier doc1 to the storage location of the document of the identifier doc6, it is required to take a path as shown in FIG. 8. That is, the number of directories to be passed through during this movement is 3. Thus, the attribute “Transit directory number” is set at this value.

As described above, the distance between two documents becomes closer in the order of (Case 1) to (Case 4). In (Case 4) where two document most closely approach to each other, in other words, if the attribute “Relation type” is set at “Host coincidence,” the distance between two documents is judged based on a value at which the attribute “Common directory depth” and the attribute “Transit directory number” are set. In this embodiment, as the standard of judging the distance between two documents, the attribute “Common directory depth” is used with priority over the attribute “Transit directory number”. For example, when comparing the distance between documents A and B with the distance between documents A and C, the document combination in which the attribute “Common directory depth” has a large value is judged that the distance is near regardless of the value of the attribute “Transit directory number”. If the value of the attribute “Common directory depth” is equal, the document combination in which the attribute “Transit directory number” has a small value is judged that the distance is near.

FIGS. 5 and 6 show the details of the step S120 as shown in FIG. 4. The processing operation (document weight calculation process) of the locational relation calculation section 162 will be explained with reference to those figures,

The locational relation calculation section 162 judges the locational relation of a plurality of documents Uᵢⱼ (j=1, 2, . . . , n) describing personal names Pᵢ (i=1, 2, . . . , m) acquired by the word acquisition section 140 in the prior step S110, the judgment being carried out every personal name as acquired. In this embodiment, it is temporarily defined that a personal name P₁ is “Taro Tanaka” and a personal name P₂ is “Hanako Sato.” With the definition of the personal name P₁ like this, the documents Uᵢⱼ are defined as follows. That is, a document U₁₁=“Document of identifier doc1,” a document U₁₂=“Document of identifier doc2,” a document U₁₃=“Document of identifier doc6,” a document U₂₁=“Document of identifier doc4,” and a document U₂₂=“Document of identifier doc5.”

(Step S120-01)

A counter i for setting an objective personal name is initialized to be “1.” In other words, there is carried out the processing for judging the distance between documents describing P₁=“Taro Tanaka.”

(Step S120-02)

If i is m or less, a step S120-03 is carried out. If i is larger than m, it is meant that all the personal names P₁ to Pₘ have been completely processed, thus terminating this processing.

(Step S120-03)

A counter j for designating an objective document is initialized to be “1.” Then, the proximity documents among documents Uᵢⱼ (the first: document U₁₁=“document of identifier doc1”) are selected in sequence.

(Step S120-04)

If j is n or less, a step S120-05 is carried out. If j is larger than n, it is meant that all the documents Uᵢₗ to Uᵢₙ have been completely processed. Then, the processing jumps to the step S120-20 for count-up of i.

(Step S120-05)

As will be described later, in this embodiment, the locational relation between the documents Uᵢⱼ and Uᵢₖ (k=1, 2, . . . , m) is calculated in sequence by using the document Uᵢⱼ as a standard. The locational relation calculation section 162 is provided with a storage means for storing this locational relation as calculated. This storage means has three variable regions, that is, a min_typeᵢⱼ, a max_depthᵢⱼ and a min_distanceᵢⱼ, which correspond respectively to three attributes of the locational relation between the documents Uᵢⱼ and Uᵢₖ, that is, “Relation type,” “Common directory depth,” and “Transit directory number.” In this step, the storage means is initialized by setting “null” to each of the above variable regions.

(Step S120-06)

First of all, in order to calculate the locational relation between the standard document Uᵢⱼ and the document Uᵢₖ, a counter k is initialized to be “1.”

(Step S120-07)

In order to avoid the calculation between the same documents, if i and k coincides with each other, the processing jumps to the step S120-18. But if not, a step S120-08 is carried out.

(Step S120-08)

If k is n or less, a step S120-09 is carried out. If k is larger than n, it is meant that the calculation of the locational relation between the standard documents Uᵢⱼ and the document Uᵢₖ has been completed. Then, the processing jumps to the step S120-19 for count-up of j.

(Step S120-09)

Here, there is calculated three attributes of the locational relation between the standard documents Uᵢⱼ and the document Uᵢₖ, that is, “Relation type (typeᵢⱼₖ),” “Common directory depth (depthᵢⱼₖ),” and “Transit directory number (distanceᵢⱼₖ).”

For example, if the document Uᵢⱼ is the document of the identifier doc1 as shown in FIG. 2 and the document of the identifier doc6 as shown in the same, the value of the attribute “Common directory depth” is “1” while the value of the attribute “Transit directory number” becomes “3.”

The value of the attribute “Transit directory number” is calculated according to the following procedure.

First of all, two character strings indicative of respective URL's of the documents Uᵢⱼ and the document Uᵢₖ, are compared with each other by means of the front string matching method, thereby extracting the common character string to both documents as well as the not common one. For example, when comparing the URL of the document of the identifier doc1 with the URL of the document of the identifier doc6, the common character string is:

“http://www.aaa.co.jp/aa/.”

If the pattern matching method is applied to this character string, it is possible to discriminate that a part of this character string “http://www.aaa.cojp” includes the name of a domain as well as the name of a machine, and also, a description location of the directory can be specified with ease.

In the next, two character strings which are not common to both of the above two URL's:

“bb/index.htm1” and “cc/dd/index.htm1”

are compared and the number of signs “/” indicative of the end of each character string are counted. The sum of the number of this sign “/” corresponds to the attribute “Transit directory number.” For example, the character string “bb/index.htm1” included in the URL of the document of identifier doc1 has one sign “/,” while the character string “cc/dd/index. htm1” included in the URL of the document of identifier doc6 has two of sign “/.” Accordingly, the attribute “Transit directory number” of the locational relation between the document of identifier doc1 and the document of identifier doc6 is set at a value of 3.

(Step S120-10)

Hereafter, in the step S120-09, it is judged whether the document Uᵢₖ can be the proximity document of the document Uᵢⱼ.

If both of the following conditions 1 and 2 are satisfied, step S120-11 are carried out, but if not, step S120-12 are carried out.

[Condition 1]

A value of the attribute “Relation type (typeᵢⱼₖ)” in the locational relation between the document Uᵢⱼ and the document Uᵢₖ is “Domain coincidence.”

[Condition 2]

A value of the variable region min_typeᵢⱼ in the storage means of the locational relation calculation section 162 is “null.”

(Step S120-11)

The variable region min_typeᵢⱼ in the storage means of the locational relation calculation section 162 is set at “Domain coincidence.” Then, the processing jumps to the step S120-18.

(Step S120-12)

If both of the following conditions 3 and 4 are satisfied, the step S120-13 is carried out, but if not, the step 120-14 is carried out.

[Condition 3]

A value of the attribute “Relation type (typeᵢⱼₖ)” in the locational relation between the document Uᵢⱼ and the document Uᵢₖ is “Sub-domain coincidence.”

[Condition 4]

A value of the variable region min_typeᵢⱼ in the storage means of the locational relation calculation section 162 is “null” or “Domain coincidence”

(Step S120-13)

The variable region min_typeᵢⱼ in the storage means of the locational relation calculation section 162 is set at “Sub-domain coincidence.” Then, the processing jumps to the step S120-18.

(Step S120-14)

If both of the following conditions 5 and 6 are satisfied, the step S120-15 is carried out, but if not, the processing jumps to the step 120-18.

[Condition 5]

A value of the attribute “Common directory depth (depthᵢⱼₖ)” in the locational relation between the document Uᵢⱼ and the document Uᵢₖ is other than “null.”

[Condition 6]

A value of the variable region max_depthᵢⱼ in the storage means of the locational relation calculation section 162 is “null” or equal or lower than the attribute “Common directory depth (depthᵢⱼₖ)” in the locational relation between the documents Uᵢⱼ and Uᵢₖ.

(Step S120-15)

The variable region max_depthᵢⱼ in the storage means of the locational relation calculation section 162 is set at a value of the attribute “Common directory depth (depthᵢⱼₖ)” in the locational relation between the documents Uᵢⱼ and Uᵢₖ. Besides, the variable region min_typeᵢⱼ in the storage means of the locational relation calculation section 162 is set at “Host coincidence.”

(Step S120-16)

If the following condition 7 is satisfied, the step S120-17 is carried out while if not, the processing jumps to the step S120-18.

[Condition 7]

A value of the variable region min_distanceᵢⱼ in the storage means of the locational relation calculation section 162 is “null” or equal to or more than the value of the attribute “Transit directory number (distanceᵢⱼₖ)” in the locational relation between documents Uᵢⱼ and Uᵢₖ.

(Step S120-17)

The variable region min_distanceᵢⱼ in the storage means of the locational relation calculation section 162 is set at the value of the attribute “Transit directory number (distanceᵢⱼₖ)” in the locational relation between documents Uᵢⱼ and Uᵢₖ.

(Step S120-18)

A value “1” is added to the counter k and then, the processing returns to the step S120-07. The locational relation between the standard document Uᵢⱼ and the next document Uᵢₖ is calculated.

(Step S120-19)

A value “1” is added to the counter j and then, the processing returns to the step S120-04. The locational relation between the standard document Uᵢⱼ and the next document Uᵢₖ is calculated.

(Step S120-20)

A value “1” is added to the counter i and then, the processing returns to the step S120-02. Then, there is carried out the processing for judging the distance between documents describing the next personal name (e.g., P₂=“Hanako Sato”).

As has been described so far, with the operation in the step S 120 (S120-01 to S120-20) of the locational relation calculation section 162, there is decided the locational relation between a plurality of documents describing each of personal names which are outputted from the word acquisition section 140.

In this embodiment, the word acquisition section 140 outputs personal names “Taro Tanaka” and “Hanako Sato.” The personal name “Taro Tanaka” is described in the documents of identifiers doc1, doc2 and doc6, respectively, and the personal name “Hanako Sato” is described in the documents of identifiers doc4 and doc5, respectively. In this case, the processing result by the locational relation calculation section 162 is as follows.

It is judged that a proximity document of the document (identifier doc1) including the personal name “Taro Tanaka” is the document of the identifier doc2. The locational relation of these documents is defined as follows.

Relation type=“Host coincidence”

Common directory depth=“1”

Transit directory number=“1”

It is judged that a proximity document of the document (identifier doc2) including the personal name “Taro Tanaka” is the document of the identifier doc1. The locational relation of these documents is defined as follows.

Relation type=“Host coincidence”

Common directory depth=“1”

Transit directory number=“1”

It is judged that a proximity document of the document (identifier doc6) including the personal name “Taro Tanaka” is the document of the identifier doc2. The locational relation of these documents is defined as follows.

Relation type=“Host coincidence”

Common directory depth=“1”

Transit directory number=“2”

A document which is to be judged on the locational relation to the document (identifier doc4) including the personal name “Hanako Sato,” is only the document of the identifier doc5. Accordingly, the locational relation of these documents is defined as follows.

Relation type=“null”

Common directory depth=“null”

Transit directory number=“null”

A document which is to be judged on the locational relation to the document (identifier doc5) including the personal name “Hanako Sato,” is only the document of the identifier doc4. Accordingly, the locational relation of these documents is defined as follows.

Relation type=“null”

Common directory depth=“null”

Transit directory number=“null”

In short, two documents (identifiers doc4, doc5) including the personal name “Hanako Sato,” have no proximity document.

(Step S130)

The significance calculation section 166 calculates the significance on respective personal names based on the processing results of the locational relation calculation section 162. FIG. 7 shows in detail the step S130 as shown in FIG. 4. The processing operation (evaluation value calculation process) of the significance calculation section 166 will be described referring to FIG. 7.

(Step S130-01)

A counter i indicative of an objective personal name for significance calculation is initialized to be “1.”

(Step S130-02)

If i is m or less, a step S130-03 is carried out. If i is larger than m, it is meant that all the personal names P₁ to Pₘ have been completely processed, thus terminating this processing.

(Step S130-03)

In order to calculate the respective weights “getWeight” of documents Uᵢ₁, Uᵢ₂, . . . , Uᵢₙ in which the personal name Pᵢ is described, the counter j indicative of the document as a calculation object is initialized to be “1.”

(Step S130-04)

The significance “weightᵢ” of the personal name Pᵢ is initialized to be “0.”

(Step S130-05)

If j is n or less, a step S130-06 is carried out. If j is larger than n, it is meant that calculation of the weight “getWeight” on documents Uᵢₗ to Uᵢₙ has been completed, thus terminating this processing. Then, the processing jumps to the step S130-08 for count-up of i.

(Step S130-06)

The weight “getWeight” of the objective document Uᵢⱼ is set according to the following weight calculation conditions 1-1 to 1-5. In the processing of calculating the weight, the higher order condition is adopted with priority.

[Weight Calculation Condition 1-1]

In the locational relation between the document Uᵢⱼ and the proximity document of it, the value of the attribute “Relation type” is “null.” If this condition is satisfied, the weight “getWeight” of the document Uᵢⱼ is set at a value “1.0.”

[Weight Calculation Condition 1-2]

The weight calculation processing of the proximity document of the document Uᵢⱼ is not yet carried out. If this condition is satisfied, the weight “getWeight” of the document Uᵢⱼ is set at a value “1.0.” For example, this condition corresponds to such a case where when arranging the identifier of the document Uᵢⱼ and the identifier of the proximity document of the document Uᵢⱼ, in the ascending power sequence, the identifier of the proximity document is located in the lower order position.

[Weight Calculation Condition 1-3]

In the locational relation between the document Uᵢⱼ and the proximity document of this document Uᵢⱼ, the value of the attribute “Relation type” is “Domain coincidence.” If this condition is satisfied, the weight “getWeight” of the document Uᵢⱼ is set at a value “0.95.”

[Weight Calculation Condition 1-4]

In the locational relation between the document Uᵢⱼ and the proximity document of this document Uᵢⱼ, the value of the attribute “Relation type” is “Sub-domain coincidence.” If this condition is satisfied, the weight “getWeight” of the document Uᵢⱼ is set at a value “0.95.”

[Weight Calculation Condition 1-5]

In the locational relation between the document Uᵢⱼ and the proximity document of this document Uᵢⱼ, the value of the attribute “Relation type” is “Host coincidence.” If this condition is satisfied, the weight “getWeight” of the document Uᵢⱼ is set at the value obtained from either the following formula (1-1) or (1-2). In the locational relation between the document Uᵢⱼ and the proximity document of this document Uᵢⱼ, if the value of the attribute “Transit directory number” is less than “5,” the formula (1-1) is used, and if it is 5 or more, the formula (1-2) is used. Besides, in two formulas (1-1) and (1-2), the value of the attribute “Common directory depth” in the locational relation between the document Uᵢⱼ and the proximity document of this document Uᵢⱼ is substituted for p and the value of the attribute “Transit directory number” is substituted for q.

getWeight=0.9*(0.5)^{p}*(0.75)^{5-q} formula (1-1)

getWeight=0.9*(0.5)^{p} formula (1-2)

In every weight calculation of the document Uᵢⱼ, the calculated weight is added to the value of the variable region weightᵢ.

(Step S130-07)

A value “1” is added to the counter “j” and then, the processing returns to the step S130-05 to calculate the weight of the next document.

In this way, the processing steps from S130-05 to S130-07 are repeated, thereby each weight of all the documents describing the personal name Pᵢ being calculated and the calculated weight being added to the variable region weightᵢ at every calculation. As a result, the significance of the personal name Pᵢ can be obtained from the variable region weight_{i.}

(Step S130-08)

A value “1” is added to the counter “i” and then, the processing returns to the step S130-02 to calculate the significance of the next personal name (e.g., P₂=“Hanako Sato”).

As described above, when the significance calculation section 166 carries out the processing S130 (i.e., steps S130-01 to S130-08), there is decided the significance of each personal name outputted from the word acquisition section 140.

Here, each significance of personal names P₁=“Taro Tanaka” and P₂=“Hanako Sato” will be described by way of a concrete example.

Each weight of documents (identifiers: doc1, doc2, doc6) including the personal name P₁=“Taro Tanaka” is as follows.

The weight of the document with the identifier doc1: 1.00 point (weight calculation condition 1-2).

The weight of the document with the identifier doc2:

0.9*(0.5)¹*(0.75)⁵⁻¹=0.14 point (formula (1-2) of weight calculation condition 1-5).

The weight of the document with the identifier doc6:

0.9*(0.5)¹*(0.75)⁵⁻²=0.19 point (formula (1-2) of weight calculation condition 1-5).

As the result of this, the significance of the personal name P₁=“Taro Tanaka” becomes the total weight of the weight of the document with the identifier doc1, the weight of the document with the identifier doc2 and the weight of the document with the identifier doc6, that is, 1.33 points (=1.00+0.14+0.19).

On the other hand, each weight of documents (identifiers: doc4, doc5) including the personal name P₂=“Hanako Sato” is as follows.

The weight of the document with the identifier doc4: 1.00 point (weight calculation condition 1-1).

The weight of the document with the identifier doc5: 1.00 point (weight calculation condition 1-1).

As the result of this, the significance of the personal name P₂=“Hanako Sato” becomes the total weight of the weight of the document with the identifier doc4 and the weight of the document with the identifier doc5 and, that is, 2.00 points (=1.00+1.00).

Despite that the personal name P₂=“Hanako Sato” appears only in two documents (identifiers: doc4 and doc5), as URL's of these two documents are completely different from each other, the personal name P₂=“Hanako Sato” has the significance higher than the personal name P₁=“Taro Tanaka” appearing in three documents (identifiers: doc1, doc2, doc6) which are close to each other in terms of distance.

(Step S140)

The output section 170 sequentially outputs the personal name based on the processing result of the significance calculation section 166, in the descending order of the significance of it i.e. from the high significant personal name to the low one. In this embodiment, personal names are outputted in the order of “Hanako Sato” and “Taro Tanaka.”

As has been discussed above, according to the first embodiment, the locational relation between respective documents is calculated by using the URL's corresponding thereto and the significance of each personal name is judged based on this calculated locational relation. And the more the location of each document is separated away from, the higher the significance given to the personal name described in each document becomes. Accordingly, even if a certain personal name is described in many documents, it is not always judged that personal name has the high significance. The personal name described in many documents having less mutual relation is given the high significance. As the result of this, it becomes possible to extract the important personal name (personality) with high accuracy.

Besides, it noted that the locational relation method of each document in the step S120 and the significance calculation method of each personal name in the step 130 are not limited to the examples as described above. For example, the weight “getWeight” of the document Uᵢⱼ may be set at a value different from that which is mentioned above, in correspondence with the scale of the network 900, the number of documents publicly disclosed in the network 900, or the number of personal names of which the significance is to be judged.

### Second Embodiment

The word significance judgment device 100 according to the first embodiment makes use of the URL of each document when judging the locational relation between documents. To this, a word significance judgment device 200 according to the second embodiment judges the locational relation of each document based on the link relation (reference relation) between documents.

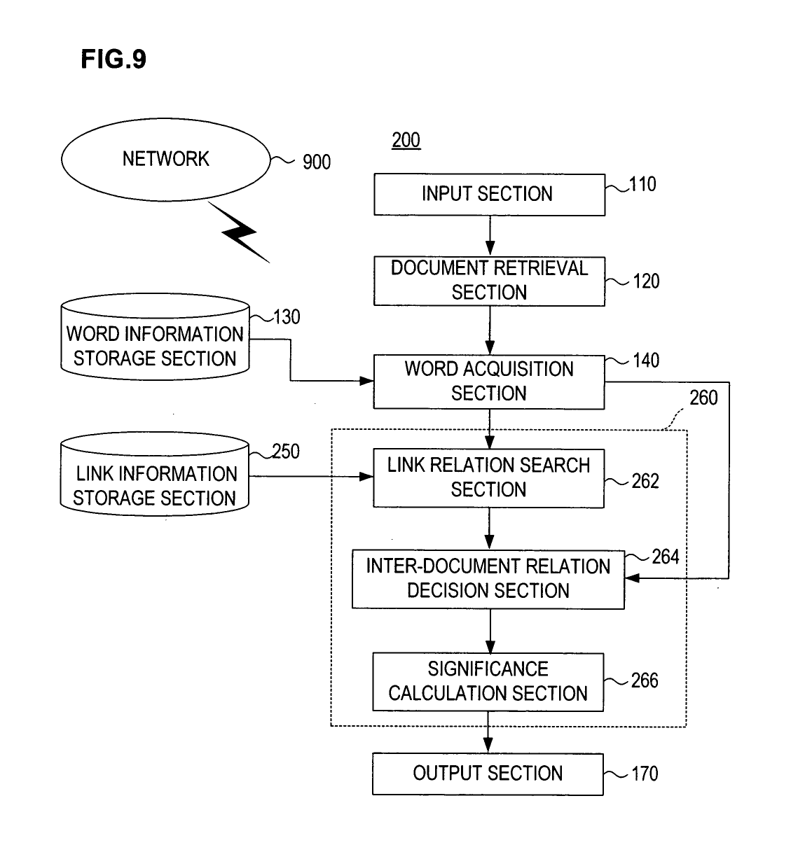

Therefore, the word significance judgment device 200 according this embodiment has such a constitution that the word significance decision 160 of the word significance judgment device 100 according to the first embodiment is replaced by a word significance decision 260 and the location information storage section 150 is replaced by a link information storage section 250. In other words, as shown in FIG. 9, the word significant judgment device 200 is made up of an input section 110, a document retrieval section 120, a word information storage section 130, a word acquisition section 140, a link information storage section 250, a word significance decision section 260, and an output section 170. Furthermore, the word significance decision section 260 is made up of a link relation search section 262, an inter-document relation decision section 264, and a significance calculation section 266.

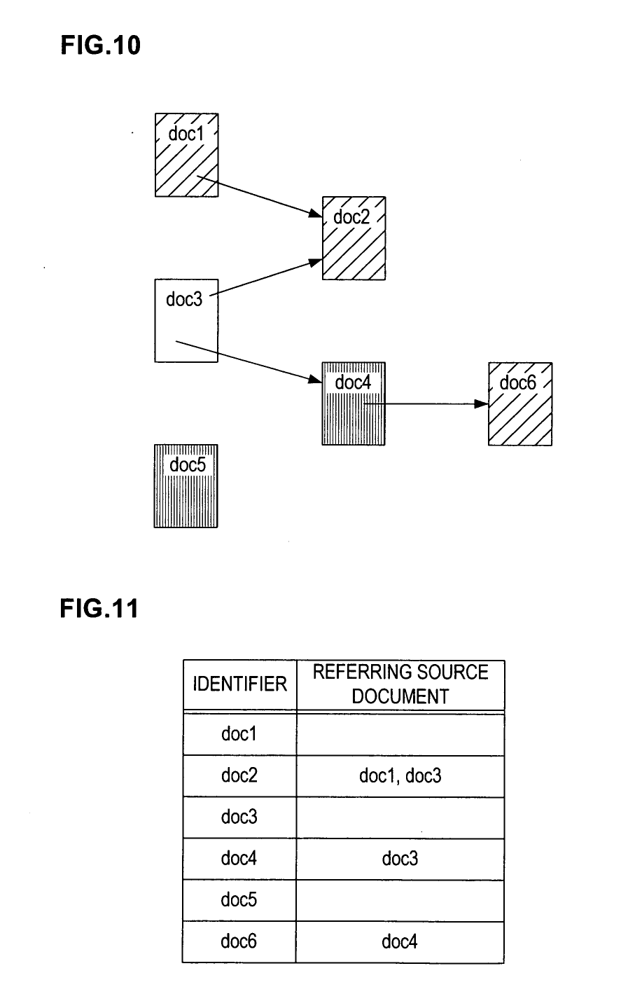

The link information storage section 250 already stores all the documents publicly disclosed in the network 900 or the link relation of the documents belonging to a predetermined category, at the time when the user inputs a retrieval keyword to the input section 110. For example, if the documents having identifiers doc1 to doc6 are publicly disclosed and forms a reference relation as shown in FIG. 10, the link information storage section 250 stores the identifiers doc1 to doc6 and the identifiers of referring source documents respectively corresponding thereto in the form of a table as shown in FIG. 11.

According to the table as shown in FIG. 11, it will be understood that the document of the identifier 2 is referred to by the document of the identifier doc1 as well as by the document of the identifier doc 3, the document of the identifier doc4 is referred to by the document of the identifier doc3, and the document of the identifier doc6 is referred to by the document of the identifier doc4.

Besides, if these documents (identifiers: doc1 to doc6) are written in the HTML (Hyper Text Markup Language), the reference relation between each document and the others is prescribed with a tag “<A>” in each document.

The word significance decision section 260 decides the significance of each personal name acquired by the word acquisition section 140.

In order to decide the significance of each personal name, the link relation search section 262 belonging to the word significance decision section 260 refers to the table (FIG. 11) showing the reference relation of each document stored in the link information storage section 250, and searches a document referred to by the document describing the personal name acquired by the word acquisition section 140 and a document referring to the document describing the personal name acquired by the word acquisition section 140.

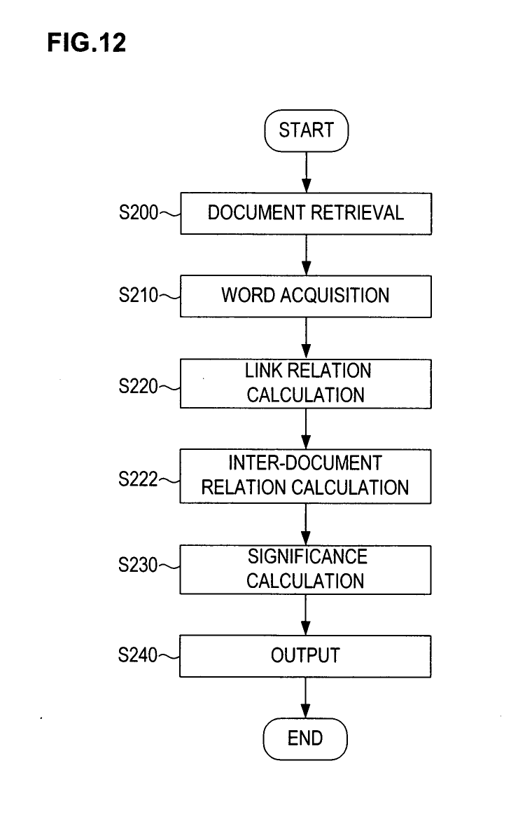

The inter-document relation decision section 264 belonging to the word significance decision section 260 decides the reference relation between documents in which each personal name acquired by the word acquisition section 140 appears, based on the output of the link relation search section 262. This reference relation is defined an attribute “Referential type” and an attribute “Distance between document.” The word significance judgment device 200 as constituted like the above according to the embodiment will now be described referring to FIG. 12 to FIG. 15.

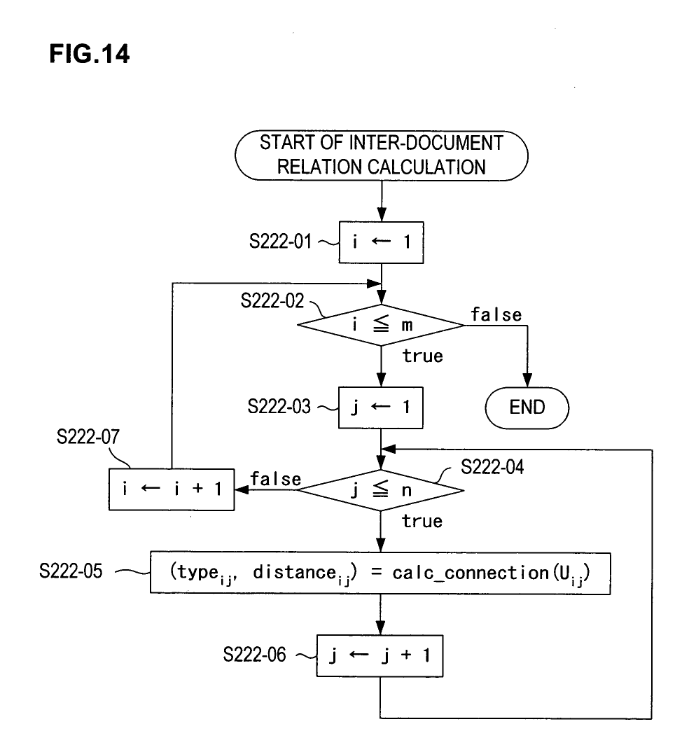

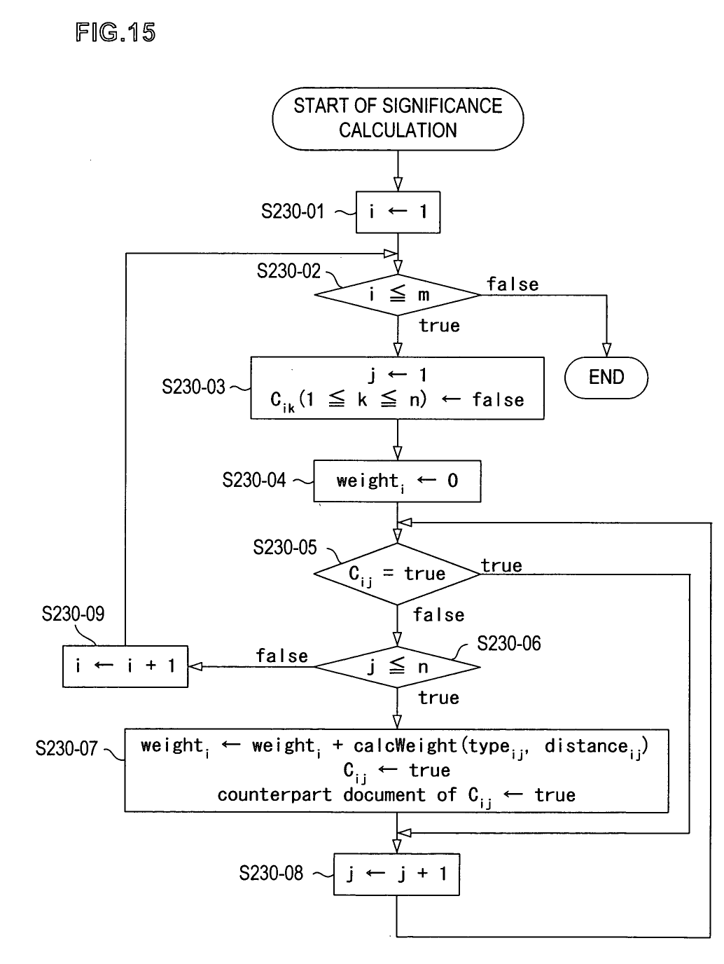

FIG. 12 is a flowchart showing a total operation of the word significance judgment device 200. FIG. 14 is a detailed flowchart showing the operation (Step S222) of the inter-document relation decision section 264. FIG. 15 is a detailed flowchart showing the operation of a significance calculation section 266.

In the following, the operation of the word significance judgment device 200 according to this embodiment will be described referring to a case where the most important person relating to the retrieval keyword “fuel cell” is extracted from a plurality of documents publicly disclosed on a network 900.

(Step S200)

First of all, when the retrieval keyword “fuel cell” is inputted to the input section 110, the document retrieval section 120 retrieves a document or documents in which the retrieval keyword “fuel cell” is described, from among a plurality of documents publicly disclosed on the network 900. For example, if documents (document assembly) publicly disclosed on the network 900 are six documents (identifiers doc1 to doc6) as shown in FIG. 2, five documents (identifiers doc1, doc2, doc4, doc5 and doc6) except the document (identifier doc3) are conformable to the retrieval keyword “fuel cell.” Then, the document retrieval section 120 gives the identifiers doc1, doc2, doc4, doc5 and doc6 of retrieved documents to the word acquisition section 140, in the form of a list.

(Step S210)

In the next, the word acquisition 140 refers to the word information (FIG. 2) stored in the word information section 130. Then, the word acquisition section 140 selects the documents of identifiers doc1, doc2, doc4, doc5, and doc6 constituting the list as given from the document retrieval section 120, and acquires words of which the assortment is “personal name” from among the words described in those selected documents.

For example, if the word information section 130 stores the word information as shown FIG. 2, the word acquisition section 140 acquires “Taro Tanaka” respectively from the documents of identifiers doc1, doc2, and doc6 as well as “Hanako Sato” respectively from the documents of identifiers doc4 and doc5.

After acquiring personal names from each document, the word acquisition section 140 collects character strings coinciding with the personal names by means of the pattern matching method and outputs the collection result as a list in the form of “Personal name-Identifiers of the document including the personal name.” An example of the output is as follows.

“Taro Tanaka”—doc1, doc2, doc6

“Hanako Sato”—doc4, doc5.

(Step S220)

In the next, the link relation search section 262 belonging to the word significance decision section 260 refers to the table stored in the link information storage section 250, and searches a document referred to by the document concerned as well as a document referring to the document concerned, with regard to the documents as listed in the list outputted by the word acquisition section 140, up to a predetermined constant “depth” by means of the breadth-first search method.

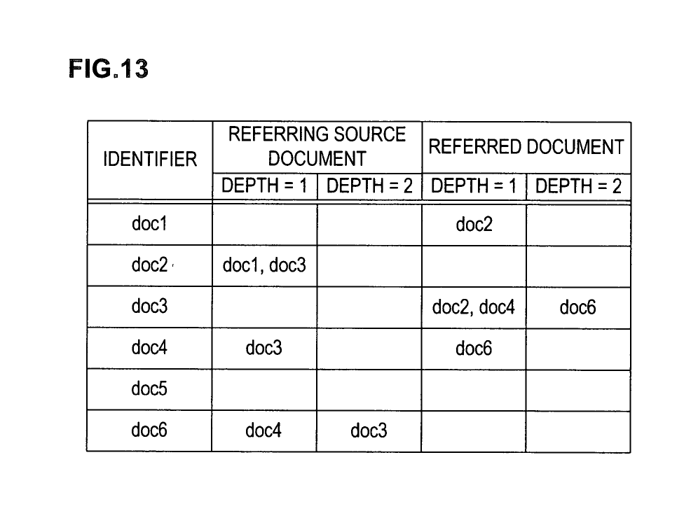

In this embodiment, “depth” indicates the hierarchical number of the document reference. Accordingly, when the first document is directly referred to by the second document, it is said that the first and second documents are in the reference relation of depth “1.” To this, when the first document is referred to by the second document, which is further referred to by the third document, the first and third documents are in the reference relation of the depth “2.” In the example as shown in FIG. 10, the document of the identifier doc6 and the document of the identifier doc2 are in the reference relation of the depth “2” through the document of the identifier doc3. In this step, as an example, when each document is referred to by the other or refers to the other, the search is carried out by the depth of “2.” FIG. 13 is a table showing the result obtained when the link relation search section 262 searches the documents (identifiers doc1 to doc6) as shown in FIGS. 10 and 11.

(Step S222)

The inter-document relation decision section 264 selects two each of documents describing each of personal names mentioned in the list outputted by the word acquisition section 140 and calculates the reference relation between respective documents.

FIG. 14 shows the detail of the step S222 in FIG. 12. The processing operation of the inter-document relation decision section 264 will be described referring to FIG. 14.

The locational relation calculation section 162 judges the locational relation of a plurality of documents Uᵢⱼ (=1, 2, . . . , n) describing personal names Pᵢ (i=1, 2, . . . , m) acquired by the word acquisition section 140 in the prior step S210, the judgment being carried out every personal name as acquired. In this embodiment, it is temporarily defined that a personal name P₁ is “Taro Tanaka” and a personal name P₂ is “Hanako Sato.” With the definition of the personal name Pᵢ like this, the documents Uᵢⱼ are defined as follows. That is, a document U₁₁=“Document of identifier doc1,” a document U₁₂=“Document of identifier doc2,” a document U₁₃=“Document of identifier doc6,” a document U₂₁=“Document of identifier doc4,” and a document U₂₂=“Document of identifier doc5.”

(Step S222-01)

A counter i for setting a processing objective personal name is initialized to be “1.” In other words, there is carried out the processing for deciding the reference relation between documents describing P₁=“Taro Tanaka.”

(Step S222-02)

If i is m or less, a step S120-03 is carried out. If i is larger than m, it is meant that all the personal names P₁ to Pₘ have been completely processed, thus terminating this processing

(Step S222-03)

A counter j for designating an objective document is initialized to be “1.” Then, the reference relation between the documents Uᵢⱼ (the first: document U₁₁=“document of identifier doc1”) and other document are calculated in sequence.

(Step S222-04)

If j is n or less, a step S222-05 is carried out. If j is larger than n, it is meant that all the documents Uᵢₗ to Uᵢₙ have been completely processed. Then, the processing jumps to the step S222-07 for count-up of i.

(Step S222-05)

The reference relation between respective documents is calculated based on the result (FIG. 10) obtained by the search operation of the link relation search section 262 in the step 220. This calculation follows the rules 1 to 3 as mentioned below.

[Rule 1]

If an identical document is included in documents referring to two documents of which the reference relation is calculable (referred to as “calculable document pair” hereinafter), in other words, if the calculable document pair is referred to by this third document (referred to as “common referring source document” hereinafter), the attribute “Referential type” of the reference relation of this calculable document pair is set at “Identical ancestor relation.” Furthermore, the attribute “Inter-document distance” of the reference relation of this calculable document pair is set at either the depth between one of the calculable document pair and the common referring source document, or the depth between the other of the calculable document pair and the common referring source document (e.g., deeper one).

For example, if the calculable document pair is constituted by the document of the identifier doc2 and the document of identifier doc6 as shown in FIG. 13, the document of identifier doc3 exists as the common referring source document. Accordingly, as the relation of this calculable document pair comes under the rule 1, the attribute “Referential type” of the reference relation of this calculable document pair is set at “Identical ancestor relation.” Besides, as the depth from the document of the identifier doc2 to the document of the identifier doc3 is “1” while the depth from the document of the identifier doc6 to the document of the identifier doc3 is “2,” the attribute “Inter-document distance” of the reference relation of this calculable document pair is set at the larger value “2.” A value “3” of the total depth may be set.

[Rule 2]

If one document of the calculable document pair is referred to by the other document, in other words, the other document refers to the one document, the attribute “Referential type” of the reference relation of this calculable document pair is set at “Ancestor-descendant relation.” Besides, the attribute “Inter-document distance” of the reference relation of this calculable document pair is set at the depth from the one document of this calculable document pair to the other document thereof (or the depth from the other document of this calculable document pair to one document thereof).

For example, if the document of the identifier doc1 and the document of identifier doc2 as shown in FIG. 13 constitute the calculable document pair, the document of the identifier doc1 refers to the document of the identifier doc2 (the document of the identifier doc2 is referred to by the document of the identifier doc1). Accordingly, as this calculable document pair comes under the rule 2, the attribute “Referential type” of the reference relation of this calculable document pair is set at “Ancestor-descendant relation.” Besides, as the depth from the document of the identifier doc 1 to the document of the identifier doc2 is “1,” the attribute “Inter-document distance” of the reference relation of this calculable document pair is set at this value “1.”

[Rule 3]

If both documents constituting the calculable document pair come under neither the rule 1 nor the rule 2, the attribute “Relation type” of the reference relation of this calculable document pair is set at “Irrelevance.” Besides, the attribute “Inter-document distance” of the reference relation of this calculable document pair is set at “null.”

For example, if the document of the identifier doc1 and the document of identifier doc6 as shown in FIG. 13 constitute the calculable document pair, as both documents come under neither the rule 1 nor the rule 2, the attribute “Relation type” of the reference relation of this calculable document pair is set at “Irrelevance.”

(Step S222-06)

After adding “1” to the counter “j,” the processing returns to the step S222-04. Then, the reference relation between the next document and the other documents is calculated in sequence.

The above steps S222-04 to S222-06 are repeated, thereby calculating the reference relation with regard to all the documents describing the personal name Pᵢ.

(Step S222-07)

After adding “1” to the counter “i,” the processing returns to the step S222-02. Then, there is calculated the reference relation of the document mentioning the next personal name (e.g., P₂=“Hanako Sato”).

As described above, when the inter-document relation decision section 264 carries out the processing step S222 (steps S222-01 to S222-07), there is decided the reference relation among a plurality of documents mentioning the concerned personal name as concerned, with regard to every personal name outputted from the word acquisition section 140.

In this embodiment, the word acquisition section 140 outputs a name “Taro Tanaka” and a name “Hanako Sato” as a personal name. The personal name “Taro Tanaka” is mentioned in documents of identifiers doc1, doc2 and doc6 while the personal name “Hanako Sato” is mentioned in documents of identifiers doc4 and doc5. In this case, the processing result of the inter-document relation decision section 264 is described as follows.

The reference relation of three documents (identifiers doc1, doc2, doc6) including the personal name “Taro Tanaka” is defined as follows.

Identifier doc1—identifier doc2

“Referential type”=“Ancestor-descendant”

“Inter-document distance”=“1”

Identifier doc1—identifier doc6

“Referential type”=“Irrelevance”

“Inter-document distance”=“null”

Identifier doc2—identifier doc6

“Referential type”=“Identical ancestor”

“Inter-document distance”=“2”

The reference relation of two documents (identifiers doc4, doc5) including the personal name “Hanako Sato” is defined as follows.

Identifier doc4—identifier doc5

“Referential type”=“Irrelevance”

“Inter-document distance”=“null”

(Step S230)

The significance calculation section 266 calculates the significance on each personal name based on the processing result of the inter-document relation decision section 264. FIG. 15 shows in detail the step S230 as shown in FIG. 12. The processing operation of the significance calculation section 266 will be described in the following referring to FIG. 15.

(Step S230-01)

The counter “i” indicative of the personal name as a calculation object of the significance is initialized to be “1.”

(Step S230-02)

If i is m or less, a step S230-03 is carried out. If i is larger than m, it is meant that all the personal names P₁ to Pₘ have been completely processed, thus terminating this processing.

(Step S230-03)

In order to calculate the respective weights “calcWeight” of documents Uᵢ₁, Uᵢ₂, . . . , Uᵢₙ in which the personal name Pᵢ is mentioned, the counter j indicative of the document as a calculation object is first initialized to be “1.”

Furthermore, the significance calculation section 266 is provided with a storage means, which stores an array made up of elements Cᵢ₁, Cᵢ₂, . . . , Cᵢₙ corresponding to each of documents Uᵢ₁, Uᵢ₂, . . . , Uᵢₙ. In this step, all the elements of the concerned array are initialized to be “false.” Besides, in the following steps, if the weight “calcWeight” of each document is calculated, the element corresponding to each document is made to be “true.”

(Step S230-04)

The significance weightᵢ of the personal name Pᵢ is initialized to be “0.”

(Step S230-05)

If the array element Cᵢⱼ is “true,” the weight “calcWeight” of the document Uᵢⱼ has been calculated already. At this time, the processing jumps to the step S230-08 in order to count up j. If the array element Cᵢⱼ is “false,” the processing executes the step S230-06.

(Step S230-06)

If j is n or less, a step S230-07 is executed. If j is larger than n, it is meant that the weight “calcWeight” of the documents Uᵢ₁ to Uᵢₙ has been completely calculated. At this time, the processing jumps to the step S230-09 in order to count up i.

(Step S230-07)

First of all, one calculable document pair of which the attribute “Inter-document distance” has a small value is selected among from a plurality of calculable document pairs including the document Uᵢⱼ. In this case, it is noted that the maximum value of the attribute “Inter-document distance” is “null.” Furthermore, if there exists a plurality of calculable document pairs of which attributes “Inter-document distance” are identical to each other, there is selected a pair of a counterpart document and the document Uᵢⱼ, the counterpart document being a document which is located in the upper order position when arranging a plurality of documents capable of making a pair with the document Uᵢⱼ in the ascending power sequence.

After having selected one calculable document pair, the weight “calcWeight” of the document Uᵢⱼ as the processing object is set according to the following weight calculation conditions 2-1 to 2-3. With regard to this weight calculation processing, it is noted that the upper condition is adopted with priority.

[Weight Calculation Condition 2-1]

The value of the attribute “Inter-document distance” of the selected calculable document pair is “null.” If this condition is satisfied, the weight “calcWeight” of the document Uᵢⱼ is set at a value “1.00” and the array element Cᵢⱼ corresponding to the document Uᵢⱼ is set at “true.” With this, it is explicitly stated that the weight “calcWeight” of the document Uᵢⱼ has been calculated.

[Weight Calculation Condition 2-2]

The weight of the counterpart document is not yet calculated (i.e., the array element C corresponding to the counterpart document U is “false”). If this condition is satisfied, the weight “calcWeight” of the document Uᵢⱼ is set at a value obtained from either the formula (2-1) or the formula (2-2). In the reference relation of the selected calculable document, if the value of the attribute “Inter-document distance” is “4” or less, the formula (2-1) is used while if that value is “4” or more, the formula (2-2) is used. In this case, the value of the attribute “Inter-document distance” is substituted for “q” of the formula (2-2). If the “Referential type” of the selected calculable document pair is “Ancestor-descendant relation,” a value of 0.85 is substituted for “p” of formulas (2-1) and (2-2), and If the “Referential type” of the selected calculable document pair is “Identical ancestor relation,” a value of 0.90 is substituted for “p” of formulas (2-1) and (2-2).

calcWeight=p^{5-q} Formula (2-1)

calcWeight=p Formula (2-2)

When the weight “calcWeight” of the document Uᵢⱼ is calculated, the array element Cᵢⱼ corresponding to the document Uᵢⱼ is set at a value of “true.” With this, it is explicitly stated that the weight “calcWeight” of the document Uᵢⱼ has been calculated.

Even if this condition is satisfied, the weight of the counterpart document U is not calculated yet. Accordingly, the weight of the counterpart document U is also calculated at this stage. As the counterpart document U constitutes the calculable document pair together with the document Uᵢⱼ, it is needless to say that the weight of the counterpart document is the same as that of the document Uᵢⱼ.

When the weight “calcWeight” of the counterpart document U is calculated, the array element C corresponding to the counterpart document U is set at a value of “true.” With this, it is explicitly stated that the weight “calcWeight” of the counterpart document has been calculated.

[Weight Calculation Condition 2-3]

The weight calculation of the counterpart document U has been completed (i.e., the array element C corresponding to the counterpart document U is “true”). If this condition is satisfied, the weight “calcWeight” of the document Uᵢⱼ is set at a value obtained from either the formula (2-1) or the formula (2-2) as mentioned above. In the reference relation of the selected calculable document pair, if the value of the attribute “Inter-document distance” is “4” or less, the formula (2-1) is used while if that value is “4” or more, the formula (2-2) is used. In this case, the value of the attribute “Inter-document distance” is substituted for “q” of the formula (2-1). Different from the case of the weight calculation condition 2-2, if the “Referential type” of the selected calculable document pair is “Ancestor-descendant relation,” a value of 0.50 is substituted for “p” of formulas (2-1) and (2-2), and If the “Referential type” of the selected calculable document pair is “Identical ancestor relation,” a value of 0.75 is substituted for “p” of formulas (2-1) and (2-2).

When the weight “calcWeight” of the document Uᵢⱼ is calculated, the array element Cᵢⱼ corresponding to the document Uᵢⱼ is set at a value of “true.” With this, it is explicitly stated that the weight “calcWeight” of the document Uᵢⱼ has been calculated.

The calculated weight of the document Uᵢⱼ and the same of the counterpart document are added to the value of the variable region weightᵢ at every calculation of the above respective weights

(Step S230-08)

A value “1” is added to the counter j and the processing is returned to the step S230-05. Then, the weight of the next document is calculated.

The above steps S230-05 to S230-08 are repeated, thereby calculating the weight of all the documents describing the personal name Pᵢ and the calculated weight being added to the value of the variable region weightᵢ at every weight calculation. As a result, the significance of the personal name Pᵢ comes to be obtained at the variable region weightᵢ.

(Step S230-09)

A value “1” is added to the counter i and the processing is returned to the step S230-02. Then, the significance of the next personal name (e.g., P₂=“Hanako Sato”) is calculated.

As described above, when the significance calculation 266 carries out the operation as mentioned in the step S230 (S230-01 to S230-09), there is decided the significance of every personal name outputted form the word acquisition section 140.

Here, the calculation of each significance of personal names P₁=“Taro Tanaka” and P₂=“Hanako Sato” will be described by way of a concrete example.

The weight of each document (identifier doc1, doc2 and doc6) including the personal name P₁=“Taro Tanaka” is as follows.

First of all, the document of the identifier doc1 is selected as the document Uᵢⱼ among from three documents (identifier: doc1, doc2 and doc3). Then, one calculable document pair of which the attribute “Inter-document distance” has the smallest value is selected among from a plurality of calculable document pairs including the document of the identifier doc1. To put it more concretely, although the document of the identifier doc1 forms the calculable document pair with the document of the identifier doc2 as well as with the document of the identifier doc6, there is selected here the calculable document pair made up of the document of the identifier doc1 and the document of the identifier doc2. At this stage, however, there is not yet calculated the weight of the document of the identifier doc2 as a counterpart document to the document of the identifier doc1. Accordingly, the weight calculation condition 2-2 is applied to this calculation.

In the calculable document pair made up of the document of the identifier doc1 and the document of the identifier doc2, as the vale of the attribute “Inter-document distance” is “1,” the formula (2-1) is used. Besides, as the attribute “Referential type” is “Ancestor-descendant relation,” a value of 0.85 is substituted for p.

Weight of the document of the identifier doc1: (0.85)⁵⁻¹=0.52 point

As the document of the identifier doc2 forms the calculable document pair with the document of the identifier doc1, its weight has the same value as the document of identifier doc1.

Weight of the document of the identifier doc2: (0.85)⁵⁻¹=0.52 point.

In the next, the processing comes into the processing loop (Step S230-08) calculating the weight of the document of the identifier doc2. However, as described above, the weight of this document has been already calculated along with the document of the identifier doc1. Accordingly, the processing jumps to the calculation process of the next document of the identifier doc6 (i.e., step S230-05)

Furthermore, in succession, the processing comes into the processing loop (Step S230-08) calculating the weight of the document of the identifier doc6. Then, one calculable document pair of which the attribute “Inter-document distance” has the smallest value is selected among from a plurality of calculable document pairs including the document of the identifier doc6. However, as the document of the identifier doc6 makes a calculable document pair only with the document of the identifier doc2, this calculable document pair is inevitably selected. At this stage, the weight of the document of the identifier doc2 as the counterpart document is already calculated as described above. Accordingly, the weight calculation condition 2-3 is applied to this calculation.

In the reference relation of the calculable document pair made up of the document of the identifier doc6 and the document of the identifier doc2, as the value of the attribute “Inter-document distance” is “2”, the formula (2-1) is used. Besides, as the attribute “Reference relation” is “Identical ancestor relation,” a value of “0.75” is substituted for “p” of the formula (2-1)

Weight of the document of the identifier doc6: (0.75)⁵⁻¹=0.32 point

As the result of this, the significance of the personal name P₁=“Taro Tanaka” is expressed as the total of each weight of the document of the identifier doc1, the document of the identifier doc2 and the document of the identifier doc6, thus it becoming 1.36 (=0.52+0.52+0.32) point.

Furthermore, the weight of each document (identifier: doc4, doc5) including the personal name P₂=“Hanako Sato” is as follows.

First of all, the document of the identifier doc4 is selected as the document Uᵢⱼ among from two documents (identifier: doc4, and doc5). Then, one calculable document pair of which the attribute “Inter-document distance” has the smallest value is selected among from a plurality of calculable document pairs including the document of the identifier doc4. However, as the document of the identifier doc4 makes a calculable document pair only with the document of the identifier doc5, this calculable document pair is inevitably selected. In the calculable document pair made up of the document of the identifier doc4 and the document of the identifier doc5, as the attribute “Reference relation” is “Irrelevance.” Accordingly, the weight calculation condition 2-1 is applied to this calculation.

Weight of the document of the identifier doc4: 1.00 point

In the next, the processing comes into the processing loop (Step S230-08) calculating the weight of the document of the identifier doc5. Then, one calculable document pair of which the attribute “Inter-document distance” has the smallest value is selected among from a plurality of calculable document pairs including the document of the identifier doc5. However, as the document of the identifier doc5 makes a calculable document pair only with the document of the identifier doc4, this calculable document pair is inevitably selected. In the reference relation of the calculable document pair made up of the document of the identifier doc5 and the document of the identifier doc4, as the attribute “Reference relation” is “Irrelevance.” Accordingly, the weight calculation condition 2-1 is applied to this calculation.

Weight of the document of the identifier doc5: 1.00 point

As the result of this, the significance of the personal name P₂=“Hanako Sato” is expressed as the total of each weight of the document of the identifier doc4 and the document of the identifier doc5, thus it becoming 2.00 (=1.00+1.00) point.

Despite that the personal name P₂=“Hanako Sato” appears only in two documents (identifiers: doc4 and doc5), as these two documents have no mutual reference relation, the significance of the personal name P₂=“Hanako Sato” becomes higher than that of the personal name P₁=“Taro Tanaka” appearing in three documents (identifiers: doc1, doc2, doc6) which have mutual reference relation among them.

(Step S240)

The output section 170 sequentially outputs the personal name based on the processing result of the significance calculation section 266, in the descending order of the significance of it i.e. from the high significant personal name to the low one. In this embodiment, personal names are outputted in the order of “Hanako Sato” and “Taro Tanaka.”

As described above, according to the second embodiment, the significance of each personal name is judged based on the reference relation of each document in which the each personal name is mentioned. Accordingly, even if a certain personal name is mentioned in a lot of documents, it is not always judged that the personal name has the high significance. The personal name mentioned in the document less relevant to the other document (rather, independent of the other document) is given the high significance.

For example, even if an identical person discloses a lot of documents including his own name through different domains, or even if members belonging to the identical group mention one member name in various documents, it is prevented that the significance of those names are highly judged against the real state of those names. As the result of this, it becomes possible to select the truly important personal name (personality) with high accuracy.

It is noted here that the calculation method of calculating the reference relation of each document as described in the step S222 as well as the calculation method of calculating the significance of each personal name are not limited to the example as described above. For example, the weight “calcWeight” of the document Uᵢⱼ may be set at a value different from the above-mentioned value in correspondence with, for example, the scale of the network 900, the number of documents publicly disclosed the network 900, the number of personal names to be judged on the significance thereof, and so forth.

### Third Embodiment

The word significance judgment device 100 according to the first embodiment calculates, at every input of a retrieval keyword to the input section 110, the locational relation among a plurality of documents mentioning the personal name related to the retrieval keyword by means of the locational relation calculation section 162 belonging to the word significance decision section 160. To this, a word significance judgment device 300 according to the third embodiment calculates, in advance (before the retrieval keyword input to the input section 110), the locational relation among all the documents publicly disclosed on the network 900 or the documents belonging to a predetermined category.

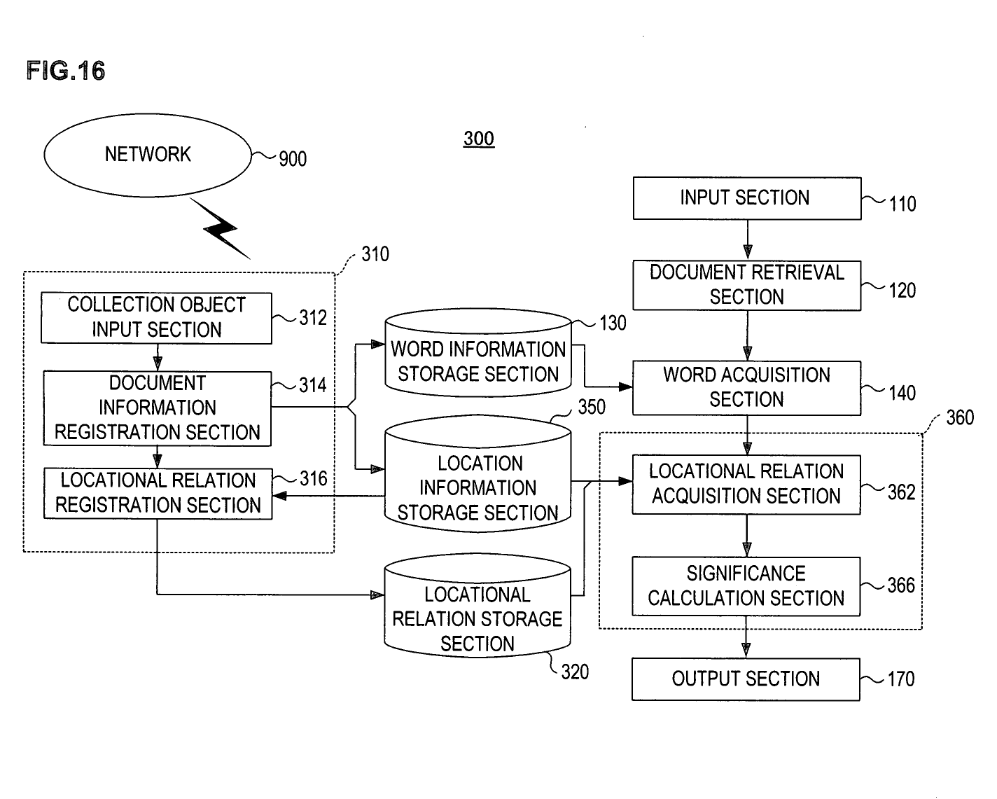

The word significance judgment device 300 has such constitution that is obtained by replacing some existing sections of the word significance judgment device 100 with corresponding sections and also, by adding some new sections thereto, to put it more concretely, by replacing the word significance decision section 160 with a word significance decision section 360, replacing the location information storage section 150 with a location information storage section 350, and further by newly adding a document collection section 310, and a locational relation storage section (document relevance storage section) 320 to the word significance judgment device 100. That is, as shown in FIG. 16, the word significance judgment device 300 is made up of the input section 110, the document retrieval section 120, the word information storage section 130, the word acquisition section 140, a location information storage section 350, a word significance decision section 360, the output section 170, a document collection section 310, and a locational relation storage section 320. Besides, a word significance decision section 360 is made up of a locational relation acquisition section 362 and a significance calculation section 366.

The document collection section 310 has the function of collecting the documents publicly disclosed on the network 900 and extracting the information of each document as collected, and the document collection section 310 is made up of a collection object input section 312, a document information registration section 314 and a locational relation registration section 316.

A user is able to designate a collection range (category) for collecting the documents on the network 900, and the collection object input section 312 accepts this designation.

The document information registration section 314 acquires the document belonging to the category as accepted by the collection object input portion 312, among all the documents publicly disclosed on the network 900. The morpheme analysis is carried out with regard to the acquired document, thereby extracting words on the basis of a part of speech. Furthermore, the named entities indicative of a personal name, an organization name and so forth are selected from the above words as extracted and are stored in the word information storage section 130. Besides, the document information registration section 314 stores the URL of the acquired document in the location information storage section 350.

The locational relation registration section 316 refers to the URL of the document acquired by the document information registration section 314 as well as to the URL of the document stored in the location information storage section 350 and calculates the locational relation between respective documents. This locational relation has the same three attributes as those in the first embodiment, that is, an attribute “Relation type,” an attribute “Common directory depth,” and an attribute “Transit directory number.”

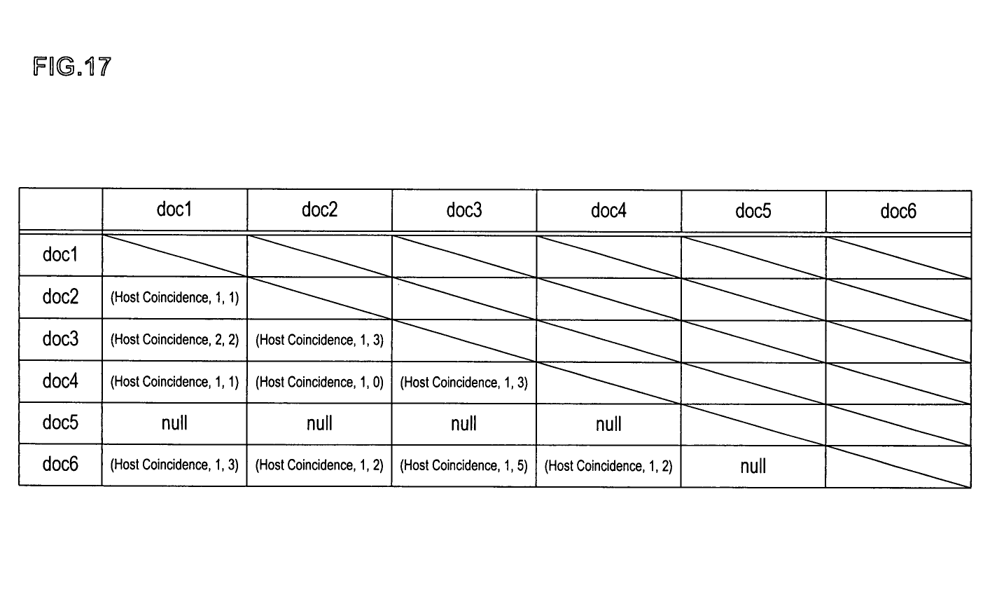

The locational relation storage section 320 stores the location of each document calculated by the locational relation registration section 316. For example, if the document information registration section 314 acquires six documents (identifier doc1 to doc6) as shown in FIG. 3 from the network 900, the locational relation storage section 320 stores each locational relation in the form of the two-dimensional array as shown in FIG. 17 with regard to all the combinations of two documents selected form these six documents. Each element of the array has a form of (the attribute “Relation type,” the attribute “Common directory depth,” and the attribute “Transit directory number”).

The locational relation acquisition section 362 belonging to the word significance decision section 360 has the same function as the locational relation calculation section 162 belonging to the word significance decision section 160 according to the first embodiment. However, as described above, in this embodiment, the calculation of the locational relation between respective documents is carried out by the locational relation acquisition section 316 belonging to the document collection section 310. Accordingly, as the locational relation acquisition section 362 is not provided with the function of calculating the locational relation between respective documents, the structure of it is simplified comparing with that of the locational relation calculation section 162.

In the next, there will now be described the operation of the word significance judgment device 300 as constituted above according to the third embodiment. The principal operation of this word significance judgment device 300 is roughly divided into the operation of “Document collection” and the operation of “Word significance calculation.”

With regard to the “Word significance calculation” of the above two operations, the operation of the word significance judgment device 300 according to this embodiment is the same as the operation (FIGS. 5 and 6) of the word significance judgment device 100 according to the first embodiment. However, the word significance judgment device 100 calculates the attribute “Relation type (typeᵢⱼₖ),” the attribute “Common directory depth (depthᵢⱼₖ),” and the attribute “Transit directory number (distanceᵢⱼₖ)” in the step S120-09 (FIG. 5). To this, according to this invention, as will be described below, the locational relation acquisition section 316 belonging to the document collection section 310 calculates in advance the locational relations of respective documents and the locational relation storage section 320 stores the result of this calculation (FIG. 17). Accordingly, the word significance judgment device 300 acquires respective locational relations from the location storage section 320 without calculating them in the step S120-09.

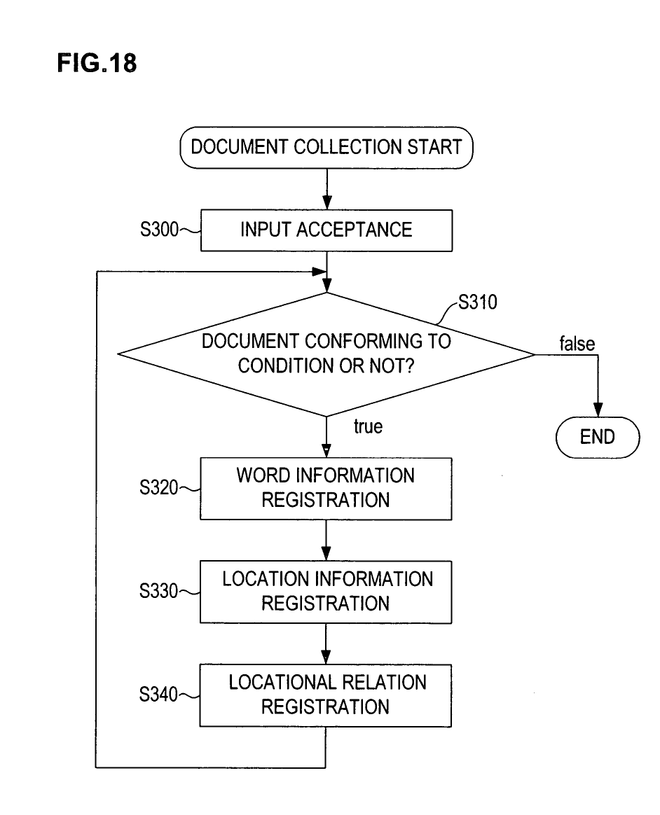

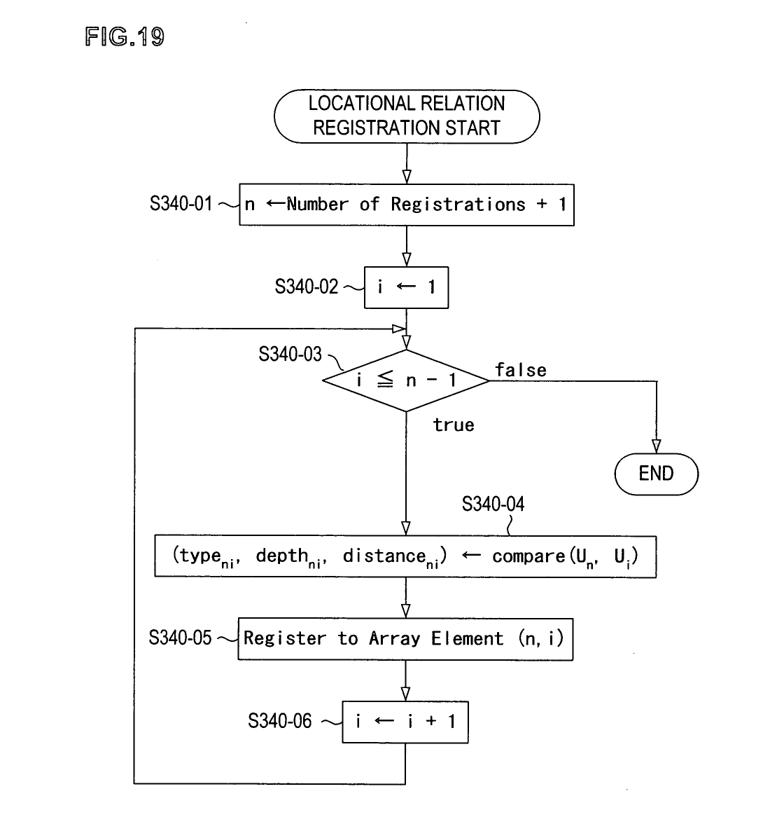

In the next, the operation (document collecting process) according to “Document collection” of the word significance judgment device 300 will be explained referring to FIG. 18.

(Step S300)

The collection object input section 301 receives the condition with regard to the document collection range as designated by the user. The user is able to designate, for example, [all the documents following “http://www.aa.co.jp”], [all the documents belonging to “co.jp” domain] and so forth.

(Step S310)

The document information registration 314 acquires the document conforming to the condition designated by the user in the step S300, from the network 900. At this stage, it is possible to use an ordinary www document collection robot. If there is no document conforming to the condition, or when all the documents conforming to the condition have collected, the processing in this step is terminated.

(Step S320)

The document information registration 314 carries out the morpheme analysis with regard to the document acquired in the step of S310 to extract words on the basis of a part of speech. Furthermore, a personal name, an organization name and so forth are selected from the above words as extracted and are stored in the word information storage section 130.

(Step S330)

Still further, the document information registration 314 stores the URL of the document acquired in the step S310 in the location information storage section 350.

(Step S340)

In the next, the locational relation registration section 316 calculates the locational relation between the document already stored in the locational relation storage section 320 and a document newly acquired in the step of S310 by the document locational relation registration 314. Then, the locational relation registration section 316 updates the array (FIG. 17) as stored in the locational relation storage section 320 based on this calculation result.

The word significance judgment device 300 repeats the processing steps from the step S310 to the step S340 in order to collect the documents conforming to the user's designated condition from the network 900.

FIG. 19 shows in detail the step S340 as shown in FIG. 18. The processing operation (document relevance storage process) of the locational relation registration section 316 will be described in the following with reference to FIG. 19. Besides, in the following explanation, the number of rows (i.e., the number of stored documents) of the array (FIG. 17) stored in the locational relation storage section 320 is indicated with n, and also, the processing operation of the locational relation registration section 316 is described referring to a case where immediately before the step S340 is carried out, the documents U₁, U₂, . . . , Uₙ₋₁ are already stored in the locational relation storage section 320 and a document Uₙ is newly added to the locational relation storage section 320.

(Step S340-01)

A value obtained by adding “1” to the number of documents stored in the locational relation storage section 320 is substituted for n. For example, if five documents U₁ to U₅ (identifiers doc1 to doc5) are stored in the locational relation storage section 320, the value is n=6.

(Step S340-02)

The counter i indicative of a document of which the locational relation to the document Uₙ is calculated is initialized to be “1.”

(Step S340-03)

If i is n−1 or less, a step S340-05 is carried out. If i is larger than n−1, it is meant that there have been completed the calculation with respect to the locational relation between the document Uₙ and the documents U₁ to Uₙ₋₁, thus terminating this processing.

(Step S340-04)

In this step, there is calculated the locational relation (the attribute “Relation type,” the attribute “Common directory depth,” and the attribute “Transit directory number”) between the documents Uₙ and Uᵢ. The operation of the locational relation registration section 316 in this step is the same as the operation in the step S120-09 of the locational relation calculation section 162 according to the first embodiment.

(Step S340-05)

Values calculated in the step S340-04 are respectively registered to the elements located at the nth-row and the ith-column of the array stored in the locational relation storage section 320.

(Step S340-06)

A value “1” is added to the counter i and then, the processing returns to the step S340-03. The locational relation between the standard document Uₙ and the next document is calculated.

As described above, when the locational relation registration section 316 carries out the step S340 (step S340-01 to step S340-06), there is calculated the locational relation between the documents having been already stored in the locational relation storage section 320 and the document newly acquired by the document information registration section 314. With this, there is updated the array (FIG. 17) stored in the locational relation storage section 320.

For example, when registering the document of the identifier doc6, there is calculated in sequence the locational relation between the document of the identifier doc6 and each of the documents of identifiers doc1 to doc6. As the result of this, the array as shown in FIG. 17 is stored in the locational relation storage section 320.

As has been discussed, according to this embodiment, it becomes possible to obtain the same effect as that which is obtained by the first embodiment. Moreover, according to this embodiment, as the locational relation of a plurality of documents publicly disclosed on the network 900 is stored in advance in the locational relation storage section 320, it becomes unnecessary to calculate the respective locational relations of a plurality of relevant documents at every input of the retrieval keyword to the input section 110. Accordingly, there is shortened the time needed for judging the significance of the personal name.

Besides, the word significance judgment device 300 according to the third embodiment calculates the locational relation of all the documents publicly disclosed on the network 900 or each document belonging to a predetermined category, but it may be possible for the word significance judgment device 300 to calculate the reference relation of each document.

While some preferred embodiments according to the invention have been discussed with reference to the accompanying drawings, the invention is not limited to those embodiments. It is apparent that anyone with ordinary skill in the art can make various changes or modifications within the category of the technical thoughts as recited in the scope of claim for patent. It is understood that those naturally belong to the technical scope of the invention.

For example, it may be possible to reconstitute the word significance judgment device 100 according to the first embodiment such that it can judge the significance of a document assembly as designated by the user or the significance of a whole document by regarding it as an object. In this case, it is possible to omit the document retrieval section 120. The same thing can be said with respect the word significance judgment device 200 according to the second embodiment and the word significance judgment device 300 according to the third embodiment.

The significance of each document may be calculated based on the locational relation of each document (the first embodiment) and the reference relation of each document (the second embodiment).

Besides, it may be possible to combine the word significance judgment processing as carried out in the word significance judgment devices 100, 200, and 300 according to the embodiments of the invention with an ordinary word significance judgment technique (e.g., the technique described in the above-mentioned Patent Document 1).

So far, the above-mentioned preferred embodiments of the invention have been described referring to a case where the significance of the personal name is judged. According to the invention, however, it is naturally possible to judge the significance of an organization name, a place name, other named entities and so forth with high accuracy.

In the word significance judgment devices 100, 200, and 300 according to the embodiments of the invention, it may be possible to provide the word acquisition section 140 with the function of extracting the named entities such as a personal name, an organization name, and so forth among form documents publicly disclosed on the network 900, thereby enabling this word acquisition section 140 to extract the named entities at every acceptance of a retrieval keyword by the input section 110. According to the constitution like this, it becomes possible to omit the word information storage section 130.

As has been discussed above, according to the invention, the significance of the named entities can be judged with accuracy and efficiency.

What is claimed is:

1. An evaluation apparatus of named entities giving an evaluation value to named entities included in a document comprising:
a document weight calculation section which defines a mutual relevance among a plurality of documents including the named entities as an object to be given the evaluation value, and calculating the weight value of said each document based on the relevance concerned; and
an evaluation value calculation section calculating the evaluation value of said named entities by carrying out the calculation processing using the weight value of said each document.

2. An evaluation apparatus as claimed in claim 1, wherein said plurality of documents is managed under a tree structure, and said document weight calculation section defines said relevance between respective documents corresponding to the existing location of said each document in said tree structure.

3. An evaluation apparatus as claimed in claim 2, wherein said document weight calculation section increases or decreases the weight value of one document and the other one document corresponding to the number of nodes of the tree structure common to the one document concerned and the other one document concerned.

4. An evaluation apparatus as claimed in claim 2, wherein said document weight calculation section increases or decreases the weight value of one document and the other one document corresponding to the number of branches of the tree structure existing between the one document concerned and the other one document concerned.

5. An evaluation apparatus as claimed in claim 2, wherein if one document and the other one document are managed under the different trees, said document weight calculation section maximizes or minimizes the weight value of the one document concerned and the other one document concerned.

6. An evaluation apparatus as claimed in claim 1, wherein said document weight calculation section defines the relevance between respective documents corresponding to the reference relation between said respective documents.

7. An evaluation apparatus as claimed in claim 6, wherein said document weight calculation section increases or decreases the weight value of one document and the other one document corresponding to whether or not there exists the third document which directly or indirectly refers to both of the one document concerned and the other one document concerned.

8. An evaluation apparatus as claimed in claim 6, wherein said document weight calculation section increases or decreases the weight value of one document and the other one document corresponding to whether or not the one document concerned directly or indirectly refers to the other one document concerned.

9. An evaluation apparatus as claimed in claim 6, wherein if there is no other one document referring to one document, said document weight calculation section maximizes or minimizes the weight value of the one document concerned.

10. An evaluation apparatus as claimed in claim 1 further comprising a document collection section collecting said plurality of document; and
a document relevance storage section storing the mutual relevance of the documents collected by said document collection section.

11. An evaluation method of named entities giving an evaluation value to named entities included in a document comprising:
a document weight calculation process defining a mutual relevance among a plurality of documents including the named entities as an object to be given the evaluation value and calculating the weight value of said each document based on the relevance concerned; and
an evaluation value calculation process calculating the evaluation value of said named entities by carrying out the calculation processing using the weight value of said each document.

12. An evaluation method as claimed in claim 11, wherein said plurality of documents is managed under a tree structure, and in said document weight calculation process, the relevance between said respective documents is defined corresponding to the existing location of said each document in said tree structure.

13. An evaluation method as claimed in claim 12, wherein the weight value of one document and the other one document is increased or decreased corresponding to the number of nodes of the tree structure common to the one document concerned and the other one document concerned.

14. An evaluation method claimed in claim 12, wherein the weight value of one document and the other one document is increased or decreased corresponding to the number of branches of the tree structure existing between the one document concerned and the other one document concerned.

15. An evaluation method as claimed in claim 12, wherein if one document and the other one document are managed under the different trees, the weight value of the one document concerned and the other one document concerned is maximized or minimized.

16. An evaluation method as claimed in claim 11, wherein in the document weight calculation process, the relevance between respective documents is defined corresponding to the reference relation between said respective documents.

17. An evaluation method as claimed in claim 16, wherein the weight value of one document and the other one document is increased or decreased corresponding to whether or not there exists the third document which directly or indirectly refers to both of the one document concerned and the other one document concerned.

18. An evaluation method as claimed in claim 16, wherein the weight value of one document and the other one document is increased or decreased corresponding to whether or not the one document concerned directly or indirectly refers to the other one document concerned.

19. An evaluation method as claimed in claim 16, wherein if there is no other one document referring to one document, the weight value of the one document concerned becomes maximum or minimum.

20. An evaluation method as claimed in claim 11 further comprising a document collection process collecting said plurality of document; and
a document relevance storage process storing the mutual relevance of the documents collected in said document collection process,
wherein said document collection process and said document relevance storage process are carried out at least before said document weight calculation process.
